(19) United States
(12) Patent Application Publication
(10) Pub. No.: US 2008/0068974 A1
(43) Pub. Date: Mar. 20, 2008

(54) OBJECTIVE LENS DRIVE APPARATUS FOR USE IN OPTICAL PICKUP

(75) Inventor: Noriyuki KAWANO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK Corporation, Tokyo (JP)

(21) Appl. No.: 11/939,944

(22) Filed: Nov. 14, 2007

Related U.S. Application Data
(62) Division of application No. 10/020,933, filed on Dec. 19, 2001.

(30) Foreign Application Priority Data
Jul. 12, 2001 (JP) 2001-211970
Jul. 25, 2001 (JP) 2001-223927
Aug. 13, 2001 (JP) 2001-245212

(51) Int. Cl. G11B 7/00

(52) U.S. Cl. 369/112.08

(57) ABSTRACT

An objective lens drive apparatus for use in an optical pickup includes a magnetic circuit including a magnet having at least three poles in a single side surface of the magnet, and a coil unit including a focus coil, a tracking coil and a tilt coil. The focus coil, the tracking coil and the tilt coil are disposed within a magnetic gap of the magnetic circuit.

### CROSS REFERENCE TO RELATED APPLICATIONS

This application is a divisional of application Ser. No. 10/020,933, filed Dec. 19, 2001 and claim priority to Japanese Patent Application Nos. 2001-211970, filed Jul. 12, 2001; 2001-223927, filed Jul. 25, 2001; and 2001-245212, filed Aug. 13, 2001; the entire contents of which are incorporated herein by reference.

### BACKGROUND OF THE INVENTION

The present invention relates to an objective lens drive apparatus for use in an optical pickup forming an optical disk unit which projects an optical spot onto a record medium to be able to read information out of the record medium optically.

An optical pickup forming an optical disk unit is generally composed of an objective lens drive apparatus including an objective lens and an optical system for transmitting the light to the objective lens and receiving the light therefrom, while the objective lens drive apparatus is disposed on an optical system block mounting table. The objective lens drive apparatus is composed of a movable part including an objective lens, a focus coil and a tracking coil, and a fixed part including a magnetic circuit; and, the movable part is supported on the fixed part by four wires each of which is in part surrounded and held by an elastic damper member such as a visco-elastic member.

As an objective lens drive apparatus which not only can drive an objective lens in a focus direction and in a tracking direction but also can correct the coma and astigmatism of a spot which is image formed on a disk, there is known an apparatus which is disclosed in Japanese Patent Publication No. Hei. 9-231595. This conventional device is characterized in that, as shown in FIGS. 38, 39 and 40, on the surface of a lens holder 1101 that is situated opposed to an optical disk, there are disposed at least a pair of optical sensors 1301, 1302 which extend in the optical disk radial direction or tangential direction of an objective lens 1103; on one or both of the side surfaces of the lens holder 1101 in the optical disk radial direction, there are disposed coils 1105 which are used to correct the inclination of the objective lens; and, on a pair of yokes 1113 and 1114 which are disposed opposed to the side surface of the lens holder 1101, there are disposed a pair of reversed-polarity magnet members 1106 and 1107 for correction of the inclination of the objective lens in such a manner that they correspond to the positions of the coils 1105, whereby the inclination of the objective lens with respect to an optical disk 1100 is detected in accordance with the outputs of the optical sensors 1301 and 1302. In accordance with the thus detected objective lens inclination angle and the calculated value of a shift between the optical axis of a collimator and the optical axis of the objective lens, currents are supplied to the coils 1105 for inclination correction to thereby drive the coils 1105 and, due to the electro-magnetic mutual reaction between the coils 1105 and the reversed polarity magnet members 1106 and 1107, the side surfaces of the lens holder 1101 are driven, so that the side surfaces of the lens holder 1101 can be servo controlled in a freely inclinable manner.

The pair of optical sensors 1301 and 1302 are respectively mounted on the two sides of the objective lens 1103 of the lens holder 1101 and, as shown in FIG. 39, are used to receive primary lights 1201, 1202 that are emitted from an optical head and diffracted by an optical disk groove. Electric signals from the optical sensors 1301, 1302, as shown in FIG. 41, are amplified by amplifiers 1407, 1408 and are then differentially input to a differential amplifier 1403. From the output of the differential amplifier 1403, there is calculated an inclination angle between the optical disk 1100 and lens holder 1101.

As shown in FIG. 41, from the thus calculated inclination angle and the shift between the objective lens optical axis and collimator optical axis, preferably, using a preset section 1404 set in a ROM (Read Only Memory), there is calculated a lens optimum inclination angle; and, based on the above two calculation results, the inclination correcting coils 1105 are driven through a phase compensation circuit 1405 and a drive amplifier 1406 for servo control.

Referring to the structure of the lens holder 1101, in the plane surface thereof, there are formed two slits 1102 through which their associated yoke members 1109 can be inserted respectively; on the central portion of the lens holder 1101, there is mounted the objective lens 1103; and, on a pair of mutually opposing side surfaces of the lens holder 1101, there are disposed square-shaped flat coils 1104 for tracking drive by twos, a total of four coils 1104. Also, on the two mutually opposing surfaces of the lens holder 1101 in the optical disk radial direction (R), as the coils 1105 for inclination correction, there are disposed a pair of square-shaped flat coils; and, above and below the coils 1105 for inclination correction, there are disposed printed circuit boards (not shown) which are supported through copper foil portions 1115, 1116.

On an actuator base 1108, there are projectingly provided yoke portions 1109, 1110; and, the yoke portions 1109, 1110, through magnets 1111, 1112, form a substantially closed magnetic circuit for focus-direction and tracking-direction driving. Also, on the two side surfaces of the actuator base 1108, there are disposed two side yokes 1113, 1114 for lens holder inclination adjustment drive, the top plan views of which respectively show a horseshoe shape. And, in each of the side yokes 1113, 1114, there are disposed long magnets 1106 and 1107 of mutually reversed polarities in such a manner that they correspond to the upper and lower sides of the coils 1105 for inclination correction.

Also, on the actuator base 1108, similarly to the above, there are further disposed square-shaped printed circuit boards 1117, 1118 through copper foil portions 1119, 1120. And, four spring wires 1121 of phosphor bronze are connected to the lens holder 1101 in such a manner that the spring wires 1121 are respectively fixed by printed circuit boards disposed on the two ends of the spring wires 1121; and thus, the lens holder 1101 is supported elastically by the spring wires 1121 (as for the fixation of the spring wires 1121, see the plan view shown in FIG. 40).

In FIG. 38, reference character F designates a focus axis of a moving system of an objective lens actuator, R stands for a tracking axis thereof, and T represents an optical disk tangent axis thereof.

Next, description will be given below of the inclination drive of the lens holder 1101 according to the related art with reference to FIG. 39. In case where the current directions of the coils 1105 for right and left inclination correction respectively disposed on the optical-disk-radial-direction two side surfaces of the lens holder 1101 are set in the same direction and the magnetic field directions of the left and right magnets 1106 and 1107 disposed so as to correspond to the upper and lower sides of the coils 1105 for inclination correction are set symmetrical, the electromagnetic driving forces of the right and left coils are different in direction from each other according to Fleming's rule (see arrow marks F, F′ in FIG. 39). Therefore, while the center of gravity or center of support of the lens holder 1101 is present substantially at the same point, in case where the lens holder 1101 is rotated about this point, the inclination of the objective lens with respect to the optical disk 1100 can be corrected.

However, in the above-mentioned conventional technique, in order to correct the inclination of the objective lens, separately from the coils and magnets for tracking servo and focus servo, there must be further disposed the coils 1105 and magnets 1106, 1107 for inclination correction, which results in the increased cost of the objective lens drive apparatus. Also, in the conventional technique, the coils 1105 and magnets 1106, 1107 for inclination correction must be disposed on the optical-disk-1100 radial direction side surfaces of the lens holder 1101 holding the objective lens 1103, which results in the increased width and weight of the objective lens drive apparatus.

### SUMMARY OF THE INVENTION

The present invention aims at solving the above problems found in the conventional technique.

Now, description will be given below of first aspect of the invention for solving the above problems with reference to FIG. 1 which corresponds to a first embodiment of the invention. According to the first aspect, within the same magnetic gap 5g of a magnetic circuit having at least one magnet 5 magnetized in multi-polarities, there is disposed a coil unit 3 on which a focus coil 3f, tracking coils 3tr and tilt coils 3ti are mounted.

In the first aspect, the magnet 5 magnetized in multi-polarities is used to make a correction of the inclination of an objective lens, which can eliminate the need for provision of an exclusive magnet exclusively used to correct the above-mentioned objective lens inclination.

Also, description will be given below of second aspect of the invention for solving the above problems with reference to FIG. 20 which corresponds to a second embodiment of the invention. According to the second the second aspect, there are completed two magnetic circuits each having at least one magnet 105 magnetized in multi-polarities and, within the magnetic gap 105g of each of the two magnetic circuits, there is disposed a coil unit 103 on which a focus coil 103f, tracking coils 103tr and tilt coils 103ti are mounted.

In the second aspect, the magnet 105 magnetized in multi-polarities is used to make a correction of the inclination of an objective lens, which can eliminate the need for provision of an exclusive magnet exclusively used to correct the objective lens inclination.

Further, description will be given below of third aspect of the invention for solving the above problems with reference to FIG. 27 which corresponds to a third embodiment of the invention. According to the third aspect, there is provided an objective lens drive apparatus for use in an optical pickup which detects the inclination of an optical disk and adjusts the inclination of an objective lens in accordance with an optical disk inclination signal, wherein, within the same magnetic gap 205g of a magnetic circuit having at least one magnet 205 magnetized in multi-polarities, there is disposed a coil unit 203 on which a plurality of focus coils 203fl, 203fr and tracking coils 203t are mounted. Currents are respectively supplied to the plurality of focus coils 203fl, 203fr and, due to the sum of the driving forces of the focus coils 203fl, 203fr, focus servo is executed. Due to the difference between the above driving forces, there is produced moment around the center of gravity of a movable part and the inclination of the objective lens 202 can be thereby adjusted simultaneously with the focus servo operation.

In the third aspect, due to the operations of the plurality of focus coils 203fl and 203fr, not only the focus servo but also the adjustment of the inclination of the objective lens 202 can be executed.

### BRIEF DESCRIPTION OF THE DRAWINGS

FIG. 1 is an exploded perspective view of a first embodiment of an objective lens drive apparatus for use in an optical pickup according to the invention;

FIG. 2 is a side view of a magnetic circuit employed in the first embodiment according to the invention;

FIG. 3 is an arrangement view of the first embodiment, showing the position relationship between magnets and focus coils/tracking coils at the self-weight position of the first embodiment in the focus direction;

FIG. 4 is an arrangement view of the first embodiment, showing the position relationship between magnets and tilt coils at the self-weight position of the first embodiment in the focus direction;

FIG. 5 is an arrangement view of a modification of the first embodiment, showing the position relationship between magnets and tilt coils at the self-weight position of the modification in the focus direction;

FIG. 6 is a plan view of a magnetic circuit employed in the modification of the first embodiment;

FIG. 7 is an arrangement view of the modification, showing the position relationship between magnets and focus coils/tracking coils at the self-weight position of the modification in the focus direction;

FIG. 8 shows of a modification of a coil unit of the first embodiment;

FIG. 9 is an exploded perspective view of another modification of the first embodiment;

FIG. 10 is a plan view of a magnetic circuit employed in the objective lens drive apparatus shown in FIG. 9;

FIG. 11 is an arrangement view to show the position relationship between a magnet having four poles magnetized and tracking coils according to other example of the first embodiment of the invention, in the own weight position of this example in the focus direction;

FIG. 12 is an arrangement view to show the position relationship between a magnet having four poles magnetized and focus coils according to the example shown in FIG. 11, in the own weight position of this example in the focus direction;

FIG. 13 is an arrangement view to show the position relationship between a magnet having four poles magnetized and tilt coils according to the example shown in FIGS. 11 and 12, in the own weight position of this example in the focus direction;

FIG. 14 is an arrangement view to show the position relationship between a magnet having three poles magnetized and focus coils/tracking coils according to other example of the first embodiment of the invention, in the own weight position of this example in the focus direction;

FIG. 15 is an arrangement view to show the position relationship between a magnet having three poles magnetized and tilt coils according to other example of the first embodiment of the invention, in the own weight position of this example in the focus direction;

FIG. 16 is an arrangement view to show the position relationship between a magnet having three poles magnetized and focus coils/tracking coils other example of the first embodiment of the invention, in the own weight position of this example in the focus direction;

FIG. 17 is an arrangement view to show the position relationship between a magnet having three poles magnetized and tilt coils according to other example of the first embodiment of the invention, in the own weight position of this example in the focus direction;

FIG. 18 is an arrangement view to show the position relationship between a magnet having three poles magnetized and focus coils/tracking coils/tilt coils according to other example of the first embodiment of the invention, in the own weight position of this example in the focus direction;

FIG. 19 is an arrangement view of the position relationship between a magnet having two poles magnetized and focus coils/tracking coils/tilt coil according to other example of the first embodiment of the invention, in the own weight position of this example in the focus direction.

FIG. 20 is an exploded perspective view of a second embodiment of an objective lens drive apparatus for use in an optical pickup according to the invention;

FIG. 21 is an exploded perspective view of a modification of the second embodiment;

FIGS. 22A and 22B are plan views of a magnetic circuit employed in the objective lens drive apparatus shown in FIG. 9;

FIG. 23 is an exploded perspective view of another modification of the second embodiment;

FIG. 24 is a front view of the objective lens drive apparatus shown in FIG. 23;

FIG. 25 is an arrangement view of the modification of the second embodiment shown in FIG. 23, showing the position relationship between magnets and tracking coils/tilt coils at the self-weight position of the second embodiment in the focus direction;

FIG. 26 is an arrangement view of the modification of the second embodiment shown in FIG. 23, showing the position relationship between magnets and tracking coils/tilt coils at the self-weight position of the second embodiment in the focus direction;

FIG. 27 is an exploded perspective view of a third embodiment of an objective lens drive apparatus for use in an optical pickup according to the invention;

FIG. 28 is an arrangement view of the third embodiment, showing the position relationship between magnets and focus coils/tracking coils at the self-weight position of the third embodiment in the focus direction;

FIG. 29 is a block diagram of a circuit configuration for focus servo and inclination drive employed in the third embodiment of the invention;

FIG. 30 is an explanatory view of the focus servo and inclination drive to be executed in the third embodiment; specifically, FIG. 30A shows a case where there are produced driving forces having the same direction; and, FIG. 30B shows a case where there are produced driving forces respectively having reversed directions;

FIG. 31 is an exploded perspective view of a modification of the third embodiment;

FIG. 32 is an arrangement view of the modification of the third embodiment, showing the position relationship between magnets and focus coils/tracking coils at the self-weight position of the modification in the focus direction;

FIG. 33 is an arrangement view of other example of the third embodiment of an objective lens drive apparatus for use in an optical pickup according to the invention, showing the position relationship between a magnet having four poles magnetized and tracking coils, in the own weight position of this example in the focus direction;

FIG. 34 is an arrangement view of the example shown in FIG. 33 to show the position relationship between a magnet having four poles magnetized and focus coils, in the own weight position of this example in the focus direction;

FIG. 35 is an arrangement view of other example of the third embodiment of an objective lens drive apparatus for use in an optical pickup according to the invention, showing the position relationship between a magnet having three poles magnetized and focus coils/tracking coils, in the own weight position of this example in the focus direction;

FIG. 36 is an arrangement view of other example of the third embodiment, showing the position relationship between a magnet having three poles magnetized and focus coils/tracking coils, in the own weight position of this example in the focus direction;

FIG. 37 is an arrangement view of other example of the third embodiment, showing the position relationship between a magnet having three poles magnetized and focus coils/tracking coils, in the own weight position of this example in the focus direction;

FIG. 38 is an exploded perspective view of a conventional objective lens drive apparatus;

FIG. 39 is an explanatory view of an inclination correction driving operation to be executed in the conventional objective lens drive apparatus;

FIG. 40 is a plan view of an actuator employed in the conventional objective lens drive apparatus; and,

FIG. 41 is a block diagram of the configuration of a circuit employed in the conventional objective lens drive apparatus to execute the tilt servo.

### DETAILED DESCRIPTION OF THE PREFERRED EMBODIMENTS

### Embodiment 1

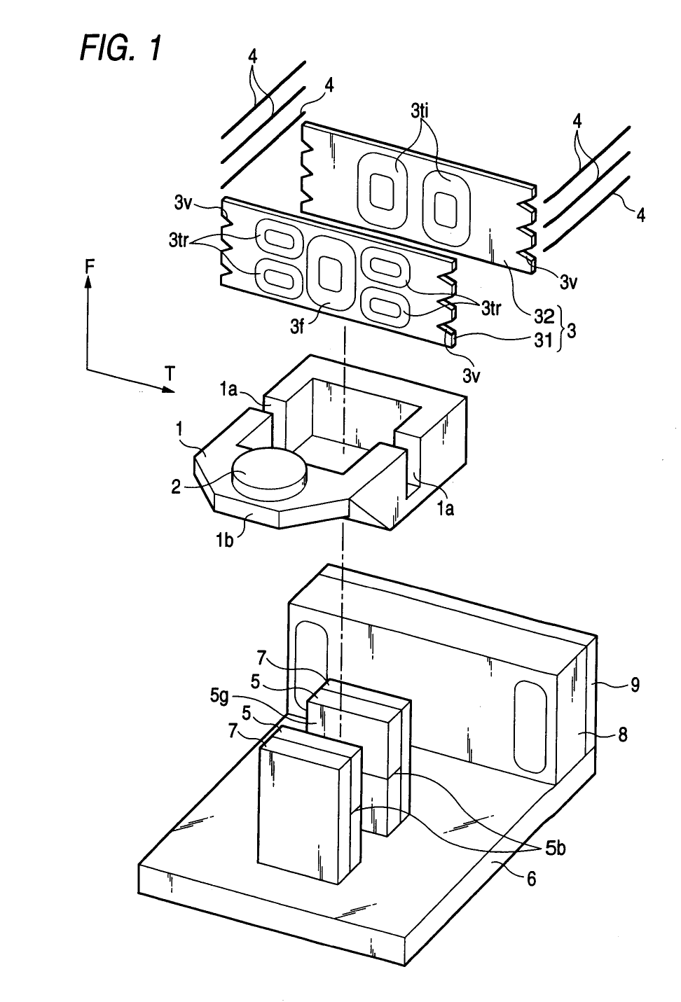

Now, FIG. 1 is an exploded perspective view of a first embodiment of an objective lens drive apparatus for use in an optical pickup according to the invention. In FIG. 1, reference character 1 designates a lens holder, 2 an objective lens, 3 a coil unit, 3f a focus coil, 3tr a tracking coil, 3ti a tilt coil, 5 a magnet, and 5g a magnetic gap, respectively.

The lens holder 1 is formed of light metal of high modulus of flexural elasticity, for example, magnesium alloy, or resin mixed with carbon fibers. Use of such material allows the lens holder 1 itself to have higher flexural elasticity modulus and thus have higher high-order resonance frequencies. Due to this, the lens holder 1 is able to cope with an increase in the speed of an optical disk unit.

In the lens holder 1, there are formed two notch portions 1a which respectively extend in the tracking direction T. Also, an objective lens mounting portion 1b, which is also formed in the lens holder 1, is structured such that it is uniform in thickness.

Each of the two notch portions 1a has a surface on which there is formed an insulated protective film (not shown) for insulation reinforcement. The reason for provision of such insulated protective film is that, since light metal of high flexural elasticity modulus such as magnesium alloy or resin mixed with carbon fibers used as the material of the lens holder 1 is high in conductivity, the insulation of the coil unit 3 to be mounted on the notch portions 1a must be secured. In case where an insulated protective film for insulation reinforcement is not formed on the surfaces of the notch portions 1a of the lens holder 1, an insulated protective film (not shown) for insulation reinforcement may be formed on the portions of the coil unit 3 that are to be mounted onto the notch portions 1a to thereby be able to secure the insulation of the coil unit 3.

The coil unit 3 is a laminated coil unit which comprises: a required number of printed circuit boards 31 each having a pattern in which a focus coil 3f and four tracking coils 3tr are formed; and, a required number of printed circuit boards 32 in each of which two tilt coils 3ti are formed, whereby the two kinds of printed circuit boards 31 and 32 are alternately laminated one on top of another to thereby provide a pattern structure as a coil unit. The focus coil 3f is disposed in the central portion of the printed circuit board 31; and, the tracking coils 3tr are disposed right and left (in the tracking coil direction T) with respect to the position of the center of gravity of an objective-lens-optical-axis-direction movable part including the lens holder 1 holding the objective lens 2, that is, on the right and left sides of the focus coil 3f in two upper and lower stages. The four tracking coils 3tr are connected in series. By the way, the tracking coils 3tr may also be composed of two tracking coils. The two tilt coils 3ti are disposed right and left (in the tracking coil direction T) with respect to the center of the printed circuit board 32. The two tilt coils 3ti are connected in series.

The printed circuit boards 31 and 32 can be laminated one on top of another, for example, by holding the two side surfaces of a printed circuit board 32 between two printed circuit boards 31 in such a manner that they are arranged symmetric when they are viewed from the tracking direction T. In this case, drive points in the respective directions can be made coincident, thereby being able to avoid resonance (pitching resonance, yawing resonance) which would be possibly caused when the drive points are not coincident.

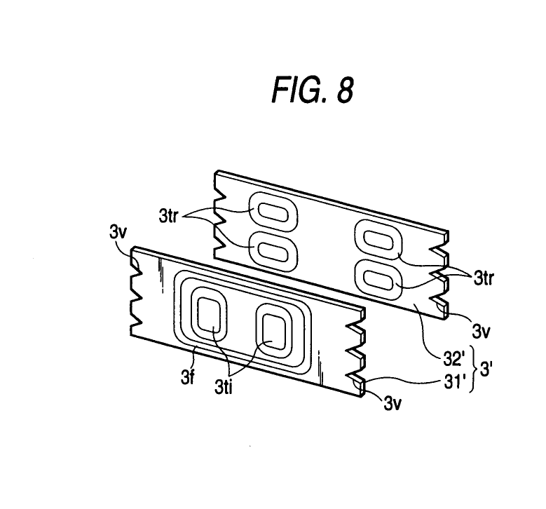

The foregoing description relates to the structure where the focus coil 3f and tracking coils 3tr are formed in each printed circuit board 31. However, the focus coil 3f and tracking coils 3tr may also be formed separately in two printed circuit boards. Further, as shown in FIG. 8, the coil unit 3′ may have a printed circuit board 31′ and a printed circuit board 32′, wherein the focus coil 3f and tilt coils 3ti are formed on the printed circuit board 31′, and the tracking coils 3tr are formed on the printed circuit board 32′. FIG. 8 shows four tracking coil 3ti are formed on the printed circuit board 32′, however, two tracking coil 3ti may be formed on the printed circuit board 32′. In these structures as well, the printed circuit boards may be laid one on top of another so as to be symmetric right and left when they are viewed from the tracking direction T, thus being able to avoid resonance by possibly caused when the drive points are not coincident.

The coil unit 3 is inserted into and bonded to the notch portions 1a so that it is fixed to the lens holder 1. In the two ends of the coil unit 3 in the tracking direction T, there are formed six V-grooves 3v, while one-end portions of six conductive elastic members 4 are respectively fixed by solder (not shown) to the six V-grooves 3v. In the case of the conductive elastic members 4 which serve as lead wires, two of them are used to drive the focus coils, two are used to drive the tracking coils, and two are used to drive the tilt coils: that is, a total of six conductive elastic members are provided. By the way, four conductive elastic members 4 are sufficient to elastically hold the lens holder 1 which serves as a movable part and, therefore, in case where four conductive elastic members 4 are used, lead wires (not shown) are to be connected to the remaining coils. However, by using four conductive elastic members 4 for driving the tilt coils, use of a flexible conductor, arrangement of a supporting member, and risk of contact with other members in driving can be avoided.

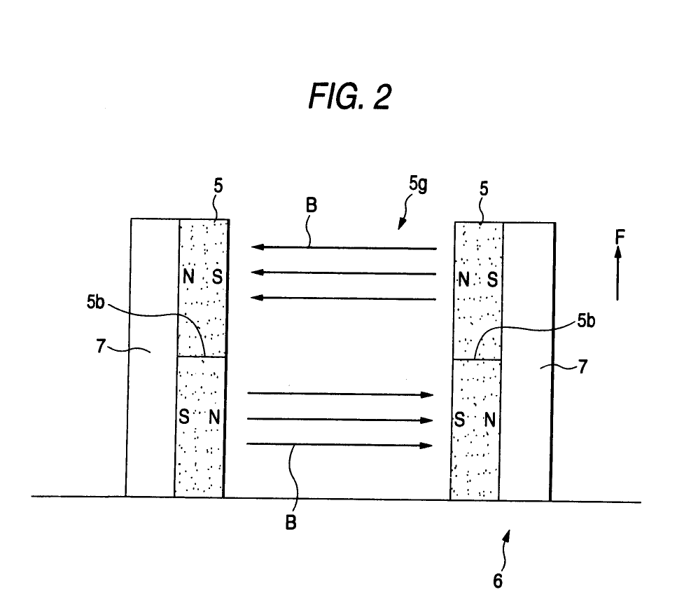

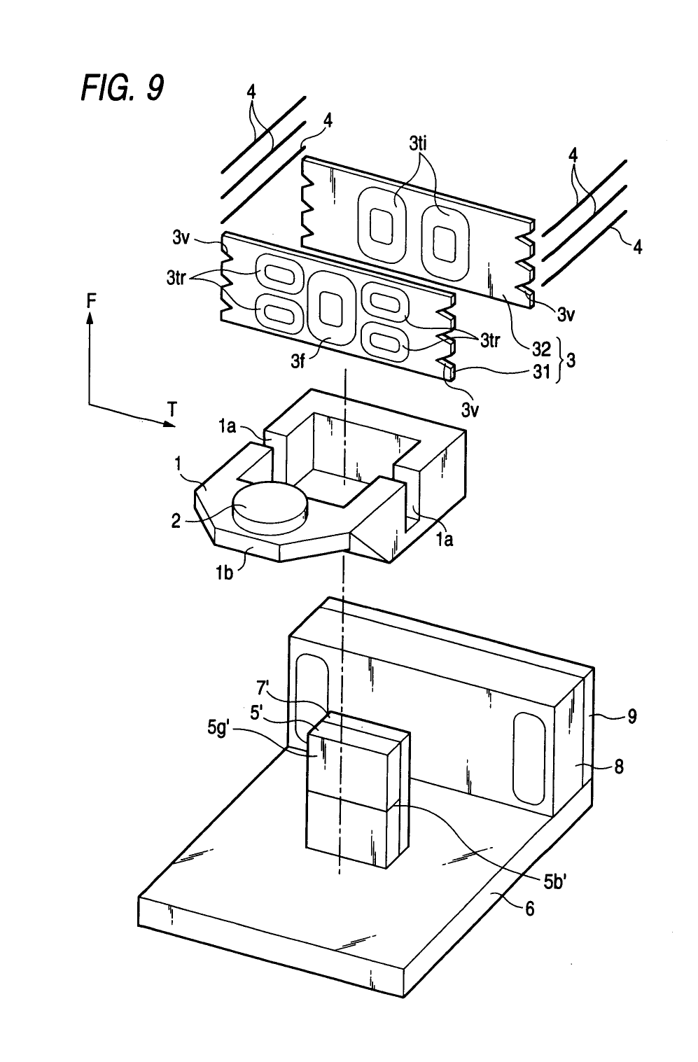

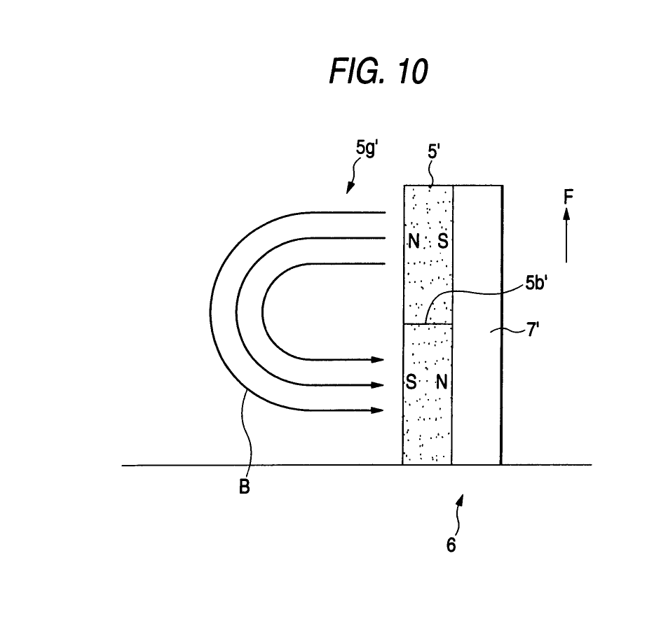

The magnet 5 is bonded to a yoke 7 disposed on a yoke base 6 in such a manner that the magnet 5 is magnetized in two polarities in the focus direction F by a boundary line 5b between the N and S poles of the magnet 5. As shown in FIG. 2, the boundary line 5b between the N and S poles is positioned at the center of the magnet 5 in the focus direction F, the mutually opposing arrangement of two magnets 5 forms a magnetic gap 5g between them, and, magnetic force lines B are reversed in direction in the focus direction F of the magnetic gap 5g. By the way, as shown in FIG. 9, the magnetic circuit may include one magnet 5′, and the coil unit may be disposed in the magnetic gap 5g′. FIG. 10 shows the magnetic circuit including the magnet 5′, similar operation of coils in the case of providing the magnetic circuit including two magnets 5 and gap 5g described above can be obtained. Due to this, the whole objective lens drive apparatus can be made compact. Here, the magnetic gap means an air gap or an air path, in FIG. 9, the magnetic gap 5g′ is formed by one magnet.

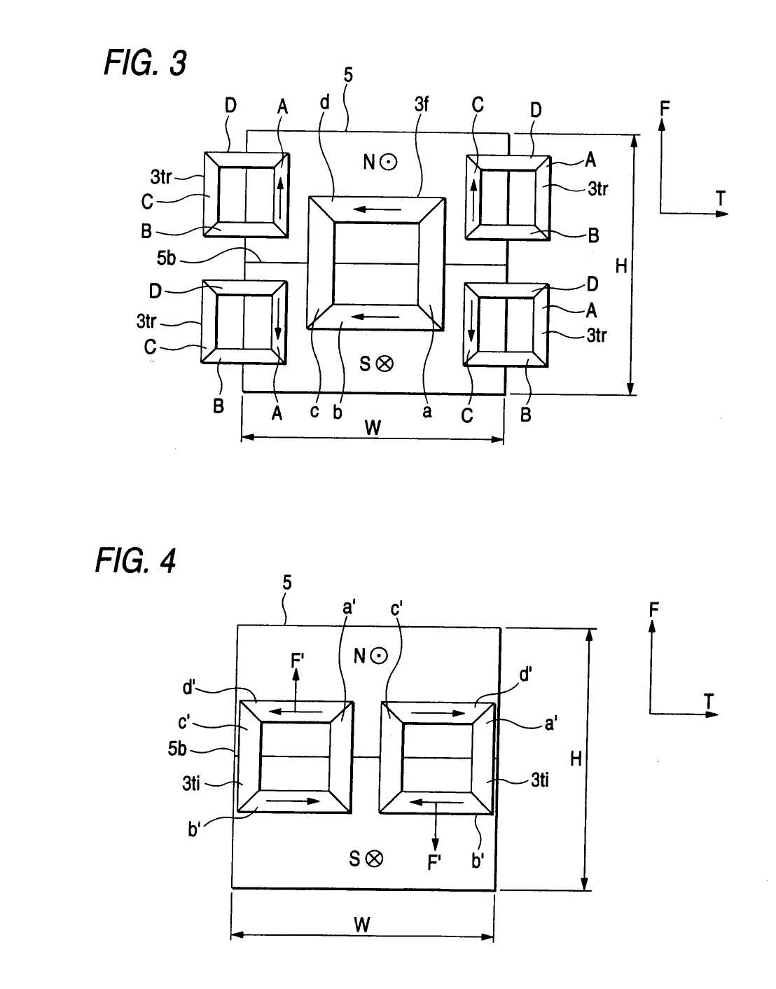

The width W of the magnet 5 is determined such that when the coil unit 3, as shown in FIG. 3, is disposed in the magnetic gap 5g at the movable neutral position of the movable part which is movably supported in a cantilevered manner by the conductive elastic members 4, that is, at the self-weight position of the movable part in the focus direction F, of the vertical sides A and C (which extend in parallel to the focus direction F) of the four tracking coils 3tr disposed right and left in the two upper and lower stages, the right and left inner vertical sides A and C can be disposed within the magnetic gap 5g (which points out a gap existing within the width W of the two mutually opposing magnets 5); and also, as shown in FIG. 4, of the vertical sides a′ and c′ (which extend in parallel to the focus direction F) of the two tilt coils 3ti disposed right and left in a row, the right and left outer vertical surfaces a′ and c′ can be disposed within the magnetic gap 5g. Also, the height H of the magnet 5 is determined such that, as shown in FIG. 3, the horizontal sides b and d (which extend perpendicularly to the focus direction F) of the single focus coil 3f disposed at the center of the printed circuit board 31 as well as the upper and lower outer horizontal sides B and D of the horizontal sides B and C (which extend perpendicularly to the focus direction F) of the tracking coils 3tr can be disposed within the magnetic gap 5g (which points out a gap existing within the height H of the two mutually opposing magnets 5); and also, as shown in FIG. 4, the horizontal sides b′ and d′ (which extend perpendicularly to the focus direction F) of the tilt coils 3ti can be disposed within the magnetic gap 5g.

The boundary line 5b between the N and S poles of the magnet 5, as shown in FIG. 3, is situated midway between the lower side b and upper side d of the horizontal sides b, d (which extend perpendicularly to the focus direction F) of the focus coil 3f, midway between the lower side B of the horizontal sides B, D (which extend perpendicularly to the focus direction F) of the upper-stage tracking coil 3tr and the upper side D of the horizontal sides B, D (which extend perpendicularly to the focus direction F) of the lower-stage tracking coil 3tr, and, as shown in FIG. 4, midway between the lower side b′ and upper side d′ of the horizontal sides b′, d′ (which extend perpendicularly to the focus direction F) of the tilt coils 3ti. The center of the magnet 5 is substantially coincident with the center of the coil unit 3.

The coil unit 3 is arranged in the magnetic gap 5g, while the other-end portions of the conductive elastic members 4 are respectively penetrated through a wire base 8 and are fixed to a base plate 9 by soldering. Due to this, the focus coil 3f, the tracking coil 3tr and the tilt coil 3ti mounted on the coil unit 3 can be disposed within the magnetic gap 105g and, at the same time, the movable part including the lens holder 1 holding the objective lens 2 is supported in a cantilevered manner so as to be movable with respect to the fixed part which includes the magnet 5, yoke base 6, yoke 7, wire base 8 and base plate 9.

In FIG. 3, in case where currents are allowed to flow in the tracking coils 3tr, due to the currents (shown by arrow marks) that flow in the vertical sides A, C which extend in parallel to the focus direction F) of the tracking coils 3tr, in the four tracking coils 3tr, there are generated driving forces in the same direction according to Fleming's left-hand rule. Also, in case where a current is allowed to flow in the focus coil 3f, due to the currents that flow in the horizontal sides b, d (which extend perpendicularly to the focus direction F) of the focus coil 3f, in the focus coil 3f, there is generated a driving force in the focus direction F according to Fleming's left-hand rule.

In FIG. 4, in case where currents are allowed to flow in the tilt coils 3ti, due to the currents (shown by arrow marks) that flow in the horizontal sides b′, d′ (which extend perpendicularly to the focus direction F) of the tilt coils 3ti, in the two tilt coils 3ti, there are generated driving forces F′ in the mutually reversed directions in the focus direction F according to Fleming's left-hand rule. Due to the mutually-reversed-direction driving forces F′, there is generated moment around the center of gravity of the movable part to thereby be able to adjust the inclination of the lens holder 1 and thus the inclination of the objective lens 2.

As described above, in case where not only the focus coil 3f and tracking coils 3tr but also the tilt coils 3ti are arranged within the same magnetic gap 5g of the magnetic circuit including at least one magnet, not only focus servo and tracking servo but also tilt servo (that is, the adjustment of the inclination of the objective lens 2) can be carried out. This can eliminate the need for provision of a magnet which is exclusively used to adjust the inclination of the objective lens 2. Due to this, the number of parts can be reduced, the adjustment of the inclination of the objective lens 2 can be made at a low cost, and the whole objective lens drive apparatus can be made compact.

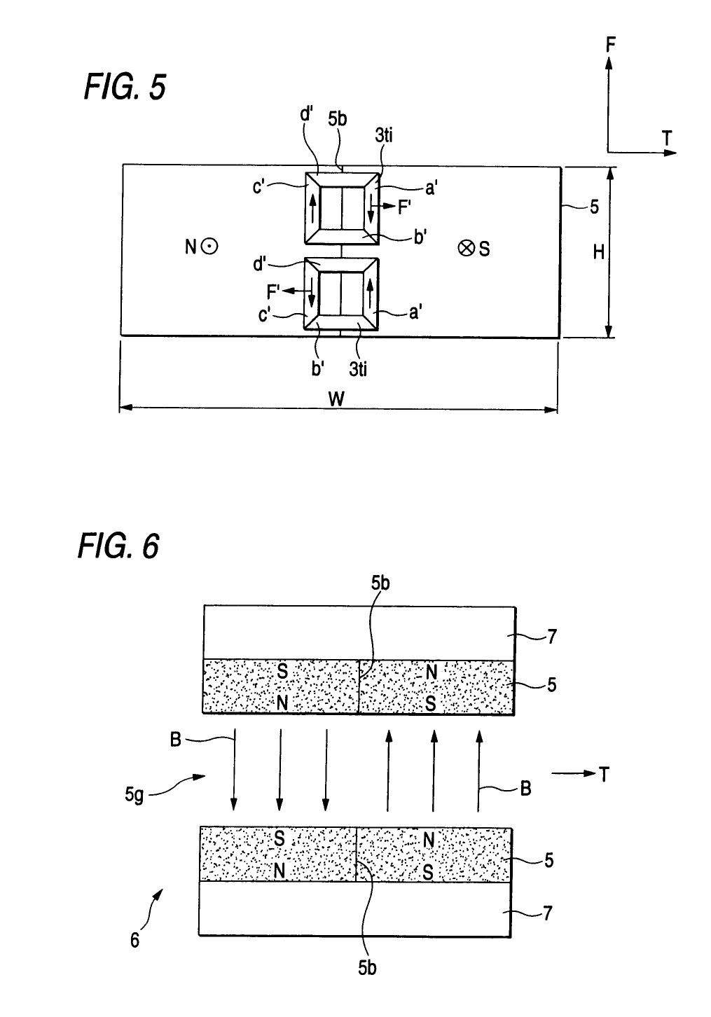

The foregoing description relates to the structure in which the two tilt coils 3ti are arranged right and left (in the tracking direction T) with respect to the center of the printed circuit board 32. However, a similar effect can also be obtained even in a structure in which, as shown in FIG. 5, two tilt coils 3ti are arranged upward and downward (in the focus direction F) with respect to the center of the printed circuit board 32.

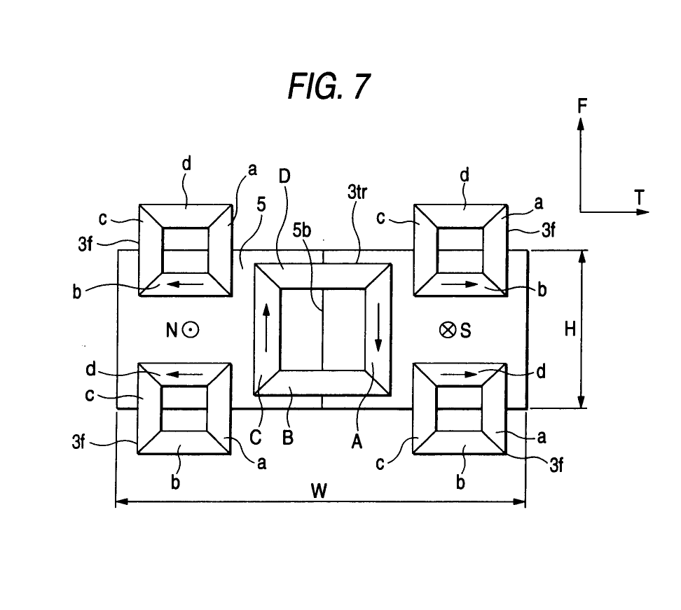

In this case, the coil unit 3 is structured such that, as shown in FIG. 7, a required number of printed circuit boards (not shown) each having a pattern including a tracking coil 3tr and four focus coils 3f and, as shown in FIG. 5, a required number of printed circuit boards (not shown) each having a pattern including two tilt coils 3ti are alternately laid one on top of another. One tracking coil 3tr is disposed in the central portion of the printed circuit board 31; and, four focus coils 3f are disposed in the right and left directions (in the tracking direction T) with respect to the position of the gravity of an objective-lens-optical-axis-direction of the movable part including the lens holder 1 holding the objective lens 2, that is, on the right and left sides of one tracking coil 3tr in two upper and lower stages. The four focus coils 3f are connected in series. The four focus coils 3f may also be replaced with two focus coils. The two tilt coils 103ti are connected in series.

The foregoing description relates to the structure in which the focus coil 3f and tracking coils 3tr are disposed on the same printed circuit board. However, there can also be employed a structure in which focus coils 3f and tracking coils 3tr are separately disposed on two printed circuit boards. In this case as well, the printed circuit boards are laid one on top of another so as to be symmetric right and left when they are viewed from the tracking direction T.

In this structure, the magnet 5, as shown in FIG. 6, is magnetized in two polarities in the tracking direction T by the boundary line 5b between the N and S poles of the magnet 5, and is bonded to the yoke 7 on the yoke base 6. As shown in FIG. 6, the boundary line 5b between the N and S poles is situated at the center of the magnet 5 in the tracking direction T, the magnetic gap 5g is formed due to the mutually opposing arrangement of the two magnets 5 and, in the magnetic gap 5g, the direction of a magnetic line of force B is reversed in the tracking direction T. By the way, alternatively, as shown in FIGS. 9 and 10, instead of the two magnets 5, there may be used a single magnet 5. In this case, the boundary line 5b′ between the N and S poles is situated at the center of the magnet 5 in the tracking direction T. Due to this, the whole objective lens drive apparatus can be made compact.

The width W of the magnet 5 is determined such that, as shown in FIG. 7, when the coil unit 3 is arranged in the magnetic gap 5g at the movable neutral position of the movable part movably supported in a cantilevered manner by the conductive elastic members 4, that is, at the self-weight position thereof in the focus direction F, not only the right and left outer vertical sides a and c of the vertical sides a and c (which extend in parallel to the focus direction F) of the four focus coils 3f arranged right and left in two upper and lower stages but also, as shown in FIG. 5, the vertical sides a′ and c′ (which extend in parallel to the focus direction F) of the two tilt coils 3ti arranged in two upper and lower stages can be respectively disposed within the magnetic gap 5g (which points out a gap existing within the width W of the mutually opposing magnets 5). Also, the height H of the magnets 5 is determined such that not only, as shown in FIG. 7, the lower sides b of the horizontal sides b, d (which extend perpendicularly to the focus direction F) of the upper-stage focus coils 3f, the upper sides d of the horizontal sides b, d (which extend perpendicularly to the focus direction F) of the lower-stage focus coils 3f, and the horizontal sides B and D (which extend perpendicularly to the focus direction F) of the tracking coil 3tr but also, as shown in FIG. 5, the upper sides d′ of the horizontal sides b′, d′ (which extend perpendicularly to the focus direction F) of the upper-stage tilt coil 3ti and the lower sides b′ of the horizontal sides b′, d′ (which extend perpendicularly to the focus direction F) of the lower-stage tilt coil 3ti can be respectively disposed within the magnetic gap 5g (which points out a gap existing within the height H of the mutually opposing magnets 5).

The boundary line 5b between the N and S poles of the magnet 5 is situated not only, as shown in FIG. 7, midway between the left sides c of the vertical sides a, c (which extend in parallel to the focus direction F) of the right focus coil 3f and the right sides a of the vertical sides a, c (which extend in parallel to the focus direction F) of the left focus coil 3f, and midway between the right side A and left side C of the vertical sides A, C (which extend in parallel to the focus direction F) of the tracking coil 3tr, but also with, as shown in FIG. 5, midway between the right side a′ and left c′ of vertical sides a′, c′ (which extend in parallel to the focus direction F) of the tilt coil 3ti. The center of the magnet 5 is substantially coincident with the center of the coil unit 3.

In FIG. 7, in case where a current is allowed to flow in the tracking coil 3tr, due to the current (shown by an arrow mark) that flows in the vertical sides A, C (which extend in parallel to the focus direction F) of the tracking coil 3tr, in the tracking coil 3tr, there is generated a driving force in the tracking direction T according to Fleming's left-hand rule; and, in case where currents are allowed to flow in the focus coils 3f, due to the currents (shown by arrow marks) that flow in the horizontal sides b, d (which extend perpendicularly to the focus direction F) of the focus coils 3f, in the four focus coils 3f, there are generated driving forces respectively having the same direction in the tracking direction T according to Fleming's left-hand rule.

In FIG. 5, in case where currents are allowed to flow in the tilt coils 3ti, due to the currents (shown by arrow marks) that flow in the vertical sides a′, c′ (which extend in parallel to the focus direction F) of the tilt coils 3ti, in the two tilt coils 3ti, there are generated driving forces in the mutually reversed directions in the tracking direction T according to Fleming's left-hand rule. Due to the reversed-direction driving forces, there is generated moment around the center of gravity of the movable part to thereby be able to adjust the inclination of the lens holder 1 and thus the inclination of the objective lens 2.

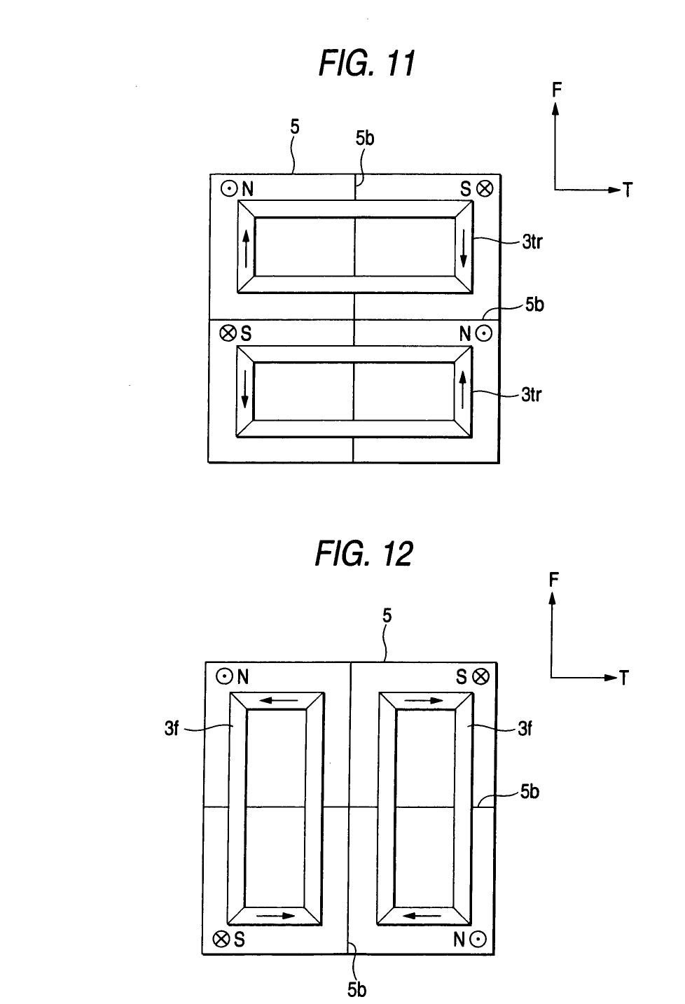

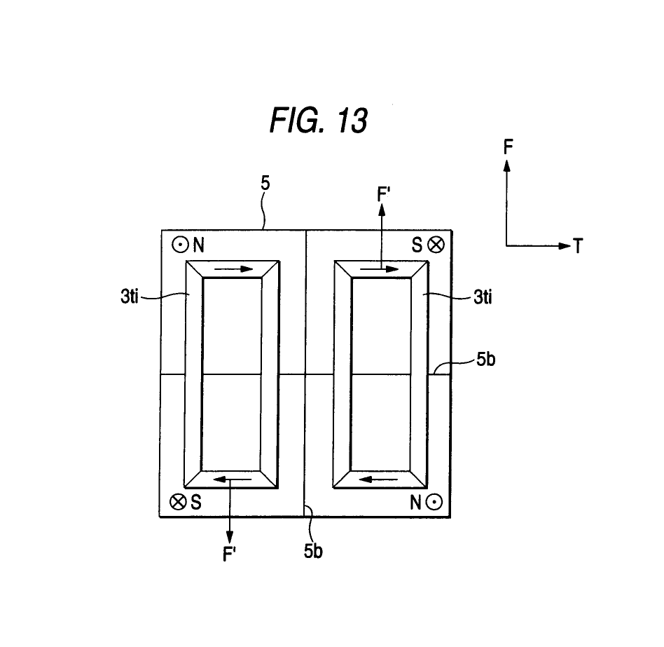

In this embodiment, the magnet 5 has two poles magnetized in the focus direction F or in the tracking direction T. However, this is not limitative but, for example, as shown in FIG. 11, the magnet 5 may include two magnet sections each having two poles magnetized in the tracking direction and respectively disposed in two upper and lower stages in the focus direction, whereby the magnet 5 has four poles magnetized. In this embodiment, as shown in FIG. 11, two tracking coils 3tr are disposed in upper and lower stages, that is, in the first and second quadrants of the magnet 5 as well as in the third and fourth quadrants of the magnet 5; and, after then, in case where currents having opposite directions are allowed to flow through the two tracking coils 3tr, in the two tracking coils 3tr, there are generated drive forces having the same direction in the tracking direction T. Also, as shown in FIG. 12, two focus coils 3f are disposed in the right and left portions of the magnet 5, that is, in the first and fourth quadrants of the magnet 5 as well as in the second and third quadrants of the magnet 5; and, after then, in case where currents having opposite directions are allowed to flow through the two focus coils 3f, in the two tracking coils 3f, there are generated drive forces having the same direction in the focus direction F. Further, as shown in FIG. 13, two tilt coils 3ti are disposed in the right and left direction, that is, in the first and fourth quadrants of the magnet 5 as well as in the second and third quadrants of the magnet 5; and, after then, in case where currents having the same direction are allowed to flow through the two tilt coils 3ti, in the two tilt coils 3ti, there are generated drive forces F′ having mutually opposite directions in the focus direction F. Due to these opposite-direction drive forces F′, there is generated the moment around the center of gravity of the movable part, which makes it possible to adjust the inclination of the lens holder 1 and thus the inclination of the objective lens 2.

Although not shown, two tilt coils 3ti may be disposed not in the right and left portions of the magnet 5 but in the upper and lower stages thereof, that is, in the first and second quadrants of the magnet 5 as well as in the third and fourth quadrants of the magnet 5, and currents having the same direction are allowed to flow through the two tilt coils 3ti. In this case, in the two tilt coils 3ti, there are generated drive forces F′ having mutually opposite directions in the tracking direction T. Due to these opposite-direction drive forces F′, there is generated the moment around the center of gravity of the movable part of the magnet 5, thereby being able to adjust the inclination of the lens holder 1 and thus the inclination of the objective lens 2.

In case where a magnet 5 is structured so as to have four poles magnetized, when compared with a magnet 5 having two poles magnetized, the number of coils is reduced from seven down to six and, therefore, the coils can be saved. Also, in the case of a magnet 5 having two poles magnetized, the portions of the coils, which are opposed to the portions for generation of the coil drive forces, must be disposed outside the magnetic gap 5g, (in FIG. 3, the A side and C side of the tracking coils 3tr; in FIG. 7, the b side and d side of the focus coils 3f). On the other hand, in the case of a magnet having four poles magnetized, it is not necessary that the present portions are disposed outside the magnetic gap 5g, which makes it easy to arrange the coils. Also, in case where the whole portion of coils are disposed within the magnetic gap 5g, the two mutually opposed sides always contribute toward generating the coil drive forces, thereby being able to enhance the use rate of the coils.

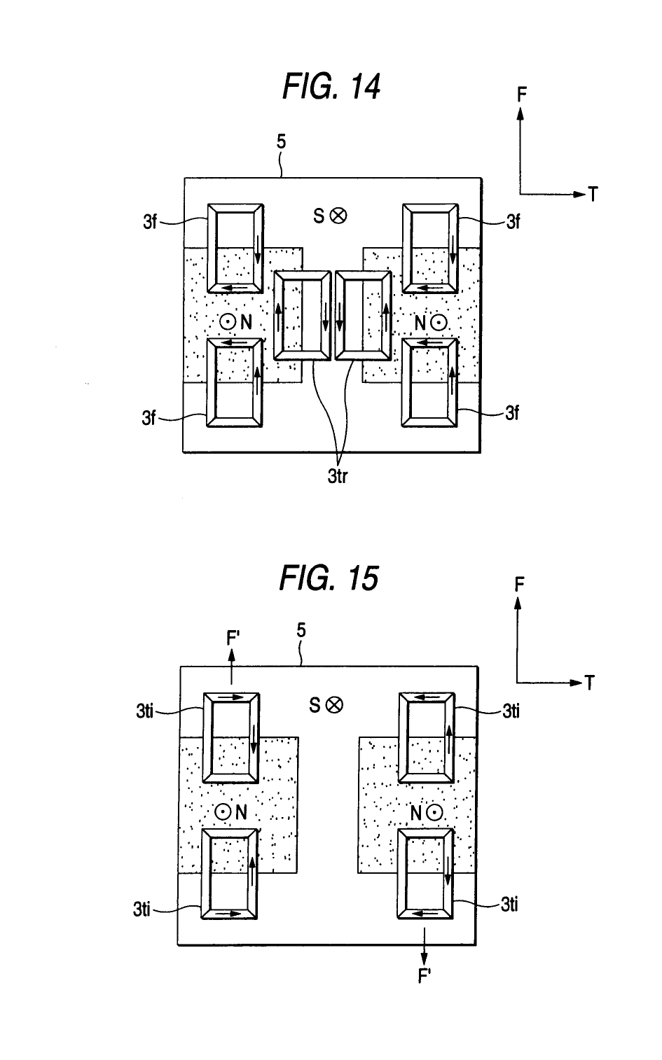

In the above embodiments, the magnet 5 has two or four poles magnetized. However, this is not limitative but, for example, there can also be used a magnet which is structured such that, as shown in FIG. 14, one pole (for example, S pole) has an I-shaped front surface and two other poles (for example, N poles) each having a quadrilateral-shaped front surface are inserted into the other space of one pole to thereby provide a quadrilateral-shaped front surface as a whole; and thus, the magnet 5 has three poles magnetized. In this case, as shown in FIG. 14, in case where two tracking coils 3tr are disposed right and left, that is, in the web portion of the I-like shape and in the N poles, and currents having the opposite directions are allowed to flow through the two tracking coils 3tr, in the two tracking coils 3tr, there are generated drive forces having the same direction in the tracking direction T. Also, as shown in FIG. 14, in case where four focus coils 3f are disposed in the right, left, upper and lower portions of the magnet 5, that is, in the upper and lower portions of the flange portion of the I-like shape and in the N poles, and currents having the same direction are allowed to flow through the two focus coils 3f disposed in the upper stage and currents, the directions of which are the same but are opposite to the directions of the currents in the upper stage, are allowed to flow through the two focus coils 3f disposed in the lower stage, there are generated in the four focus coils 3f drive forces having the same direction in the focus direction F. Also, as shown in FIG. 15, in case where four tilt coils 3ti are disposed in the right, left, upper and lower portions of the magnet 5, that is, in the upper and lower portions of the flange portion of the I-like shape and in the N poles, currents having the opposite directions are allowed to flow through the two tilt coils 3ti disposed in the upper stage, and currents, the directions of which are opposite to each other and are opposite to the directions of the currents in the upper stage, are allowed to flow through the two tilt coils 3f disposed in the lower stage, there are generated in the right and left tilt coils 3ti drive forces F′ having opposite directions in the focus direction F. Due to the drive forces F′ having opposite directions, there is generated the moment around the center of gravity of the movable part, thereby being able to adjust the inclination of the lens holder 1 and thus the inclination of the objective lens 2.

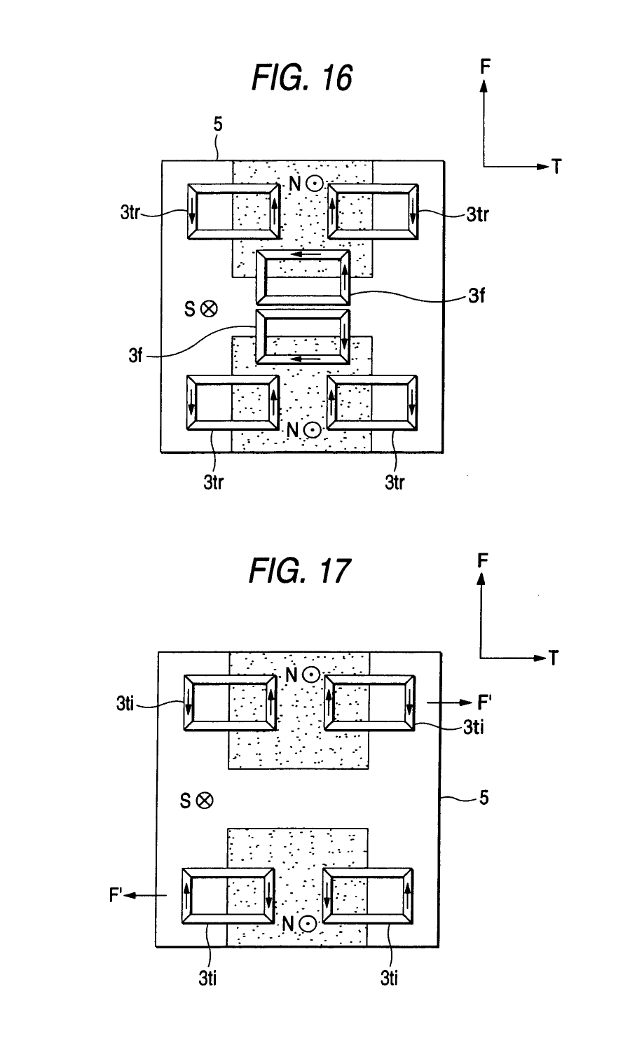

When the magnet 5 is structured such that it has three poles magnetized, as shown in FIG. 16, one pole (for example, S pole) may have an H-shaped front surface and the other two poles (for example, N poles) each having a quadrilateral-shaped front surface may be inserted into the other space of one pole to thereby provide a magnet having a quadrilateral-shaped front surface as a whole. In this case, as shown in FIG. 16, in case where four tracking coils 3tr are disposed in the right, left, upper and lower portions of the magnet 5, that is, in the right and left portions of the flange portion of the H-like shape and in the N poles, currents having the opposite directions are allowed to flow through the two tracking coils 3tr disposed in the upper stage, and currents, the directions of which are opposite to each other and are the same as the directions of the currents in the upper stage, are allowed to flow through the two tracking coils 3tr disposed in the lower stage, there are generated in the four tracking coils 3tr drive forces F′ having the same direction in the tracking direction T. Also, as shown in FIG. 16, in case where two focus coils 3f are disposed in the upper and lower portions of the magnet 5, that is, in the web portions of the H-like shape and in the N poles, and currents having opposite directions are allowed to flow through the two focus coils 3f, in the two focus coils 3f, there are generated drive forces having the same direction in the focus direction F. Also, as shown in FIG. 17, in case where four tilt coils 3ti are disposed in the right, left, upper and lower portions of the magnet 5, that is, in the right and left portions of the flange portion of the H-like shape and in the N poles, currents having opposite directions are allowed to flow through the two tilt coils 3ti disposed in the upper stage, and currents, the directions of which are opposite to each other and are opposite to the directions of the currents in the upper stage, are allowed to flow through the two tilt coils 3ti disposed in the lower stage, there are generated in the upper and lower tilt coils 3ti drive forces F′ having opposite directions in the tracking direction T. Due to the drive forces F′ having opposite directions, there is generated the moment around the center of gravity of the movable part, thereby being able to adjust the inclination of the lens holder 1 and thus the inclination of the objective lens 2.

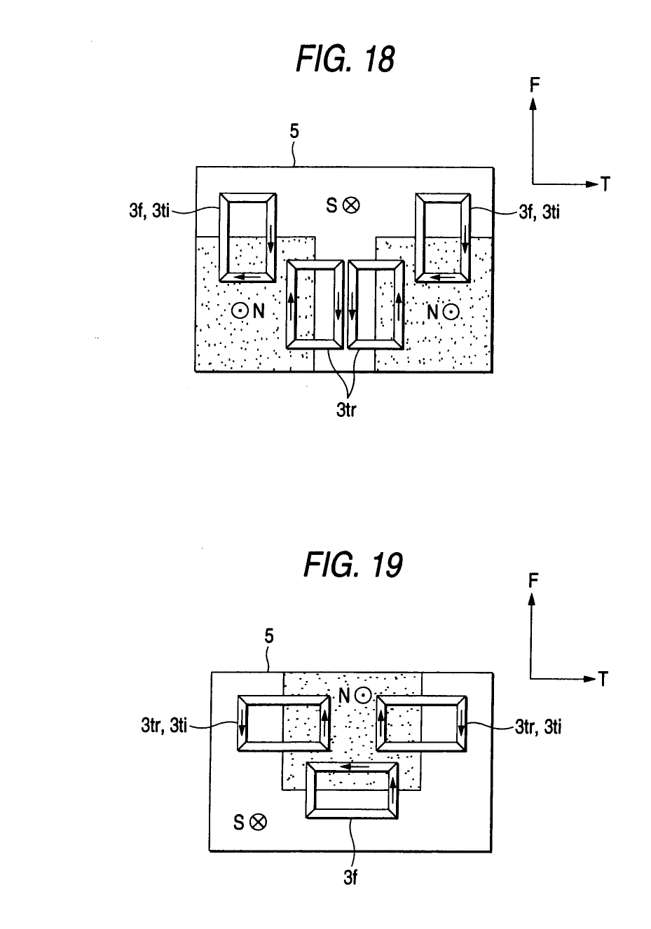

In this embodiment, there are used four tilt coils 3ti, two or four focus coils 3f and two or four tracking coils 3tr. However, in case where two tilt coils 3ti are used, as shown in FIG. 18, there can be used a magnet 5 as follows: that is, one pole (for example, S pole) has a T-shaped front surface and the other two poles (for example, N poles) each having a quadrilateral-shaped front surface are inserted into the other space of one pole to thereby provide a magnet 5 having a quadrilateral-shaped front surface as a whole; and thus, the magnet 5 has three poles magnetized. In this case, two tracking coils 3tr are disposed in the central portion of the magnet 5, that is, in the vertical portion of the T shape and in the N poles, while two focus coil 3f and two tilt coils 3ti are disposed in the right and left portions of the magnet 5, that is, in the horizontal portion of the T-like shape and in the N poles.

Also, as shown in FIG. 19, there can also be used a magnet 5 as follows: that is, one pole (for example, S pole) has a U-shaped front surface and the other pole (for example, N pole) having a quadrilateral-shaped front surface is inserted into the other space of one pole to thereby provide a magnet having a quadrilateral-shaped front surface as a whole; and thus, the magnet 5 has two poles magnetized. In this case, one focus coil 3f is disposed in the central portion of the magnet 5, that is, in the horizontal portion of the U shape and in the N pole, while two tracking coils 3tr and two tilt coils 3ti are disposed in the right and left portions of the magnet 5, that is, in the vertical portions of the U shape and in the N pole.

In the case of a magnet having three poles magnetized, when compared with a magnet having two poles magnetized, similarly to a magnet having four poles magnetized, the coil arrangement can be facilitated and thus the use rate of the coils can be enhanced.

Thus, in the case of a two-pole magnetized magnet using a U shape, a three-pole magnetized magnet and a four-pole magnetized magnet, similarly to the two-pole magnetized magnet according to the previously described first embodiment, the coil unit includes a plurality of piled-up printed circuit boards of three individual types: that is, a first type of circuit board includes one or more focus coils 3f mounted thereon, a second type includes one or more tracking coils 3tr mounted thereon, and a third type includes one or more tilt coils 3ti are mounted. Also, the coil unit may include a plurality of piled-up printed circuit boards of two types: that is, a printed circuit board of one type includes one or more focus coils 3f and one or more tracking coils 3tr mounted thereon; and, a printed circuit board of the other type includes one or more tilt coils 3ti mounted thereon. Further, the coil unit may also include a plurality of piled-up printed circuit boards of two types: that is, a printed circuit board of one type includes one or more focus coils 3f and one or more tilt coils 3ti mounted thereon; and, a printed circuit board of the other type includes one or more tracking coils 3tr mounted thereon.

In the above-mentioned structures, including the cases of a two-pole magnetized magnet using a U shape, a three-pole magnetized magnet and a four-pole magnetized magnet, the magnetic gap 5g, as shown in FIGS. 1, 2 and 6, may be defined by a single magnet 5′ as shown in FIGS. 10 and 11.

### Embodiment 2

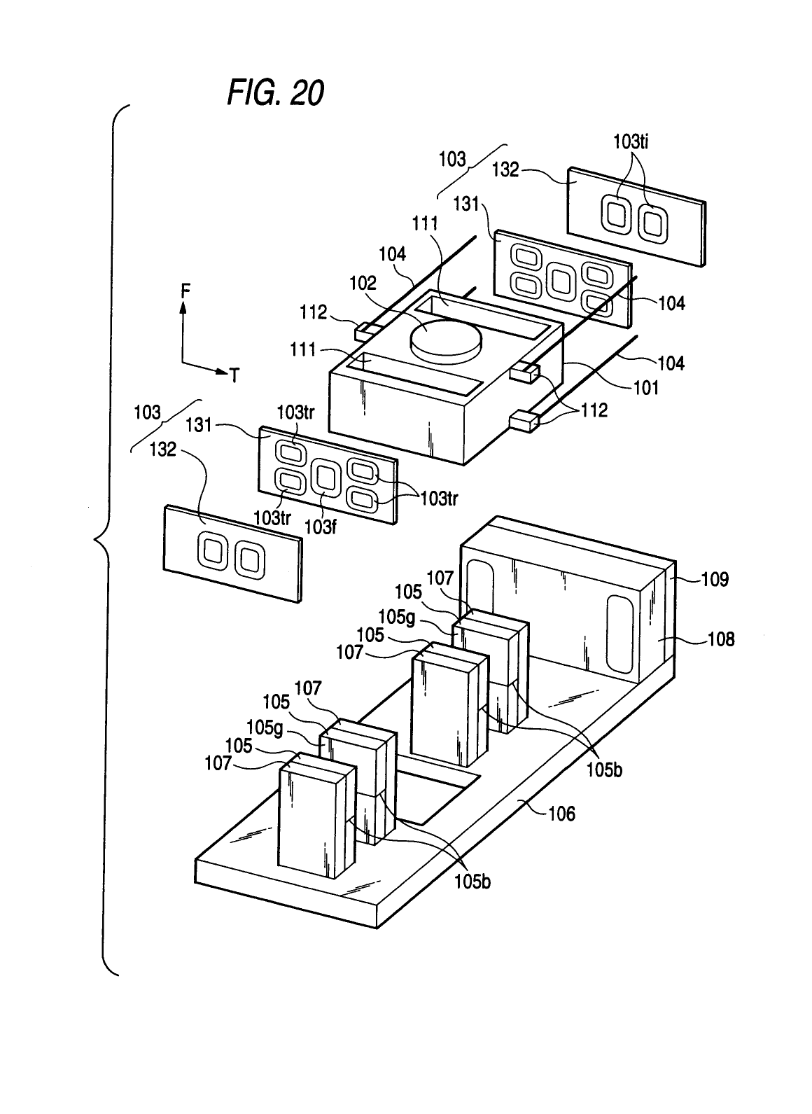

Now, FIG. 20 is a perspective view of a second embodiment of an objective lens drive apparatus according to the invention. In FIG. 20, reference character 101 designates a lens holder, 102 an objective lens, 103 a coil unit, 103f a focus coil, 103tr a tracking coil, 103ti a tilt coil, 105 a magnet, and 105g a magnetic gap, respectively.

The lens holder 101 is made of light metal of high modulus of flexural elasticity, for example, magnesium alloy, or resin mixed with carbon fibers. Use of such material allows the lens holder 101 itself to have higher flexural elasticity modulus and thus have higher high-order resonance frequencies. Due to this, the lens holder 101 is able to cope with an increase in the speed of an optical disk unit.

Referring further to the structure of the lens holder 101, on the plane surface thereof, there are formed two slits 111 through which a magnet 105 and a yoke 107 (both of which will be discussed later) can be inserted; on the central portion of the lens holder 101, there is mounted the objective lens 102; on each of a pair of side surfaces of the lens holder 101 which extend at right angles to the tracking direction T, there are projectingly disposed two upper and lower support pieces 112 to which the one-end portions of conductive elastic members 104 (which will also be discussed later) can be fixed; and, to a pair of side surfaces of the lens holder 101 which extend in parallel to the tracking direction T, there are fixed coil units 103 (which will also be discussed later).

Insulated protective films (not shown) for reinforcement are respectively formed on the surfaces of the pair of side surfaces (which extend in parallel to the tracking direction T) of the lens holder 101. The reason for provision of such insulated protective films is to secure the insulation of the coil units 103 to be mounted onto the lens holder 101 because light metal of high modulus of flexural elasticity, for example, magnesium alloy, or resin mixed with carbon fibers used as the material of the lens holder 101 is high in conductivity.

In case where such insulated protective films for reinforcement are not formed on the surfaces of the pair of side surfaces (which extend in parallel to the tracking direction T) of the lens holder 101, insulated protective films (not shown) for reinforcement may be formed on the portions of the coil units 103 that are to be mounted onto the lens holder 101, thereby securing the insulation of the coil units 103.

Referring now to the coil unit 103, a required number of printed circuit plates 131 each having a pattern composed of a focus coil 103f and four tracking coils 103tr and a required number of printed circuit plates 132 each having a pattern composed of two tilt coils 103ti are laminated or laid one on top of another to thereby form the coil unit 103. The focus coil 103f is disposed in the central portion of the printed circuit board 131; and, the tracking coils 103tr are disposed in the right and left directions (in the tracking direction T) with respect to the position of the center of gravity of an objective-lens-optical-axis-direction movable part including the lens holder 101 holding the objective lens 102, that is, on the right and left sides of the focus coil 103f in two upper and lower stages. The four tracking coils 103tr are connected in series. By the way, the four tracking coils 103tr may also be replaced with two tracking coils. The two tilt coils 103ti are disposed in a row right and left (in the tracking coil direction T) with respect to the center of the printed circuit board 32. The two tilt coils 103ti are connected in series.

The printed circuit boards 131 and 132 may be laminated in such a manner that the two side surfaces (which extend in parallel to the tracking direction T) of the printed circuit board 131 and the two side surfaces (which extend in parallel to the tracking direction T) of the printed circuit board 132 are arranged symmetric when they are viewed from the tracking direction T, for example, the printed circuit board 131 is arranged inside on the objective lens 102 side and the printed circuit board 132 is arranged outside on the objective lens 102 side. In this case, drive points in the respective directions can be made coincident with each other, thereby being able to avoid resonance (pitching resonance, yawing resonance) which would be possibly caused when the drive points are not coincident.

The foregoing description relates to the structure in which the focus coil 103f and tracking coils 103tr are formed in the same printed circuit board 131. However, the focus coil 3f and tracking coils 3tr may also be formed separately in two different printed circuit boards. Further, as shown in FIG. 8, the coil unit 3′ may have a printed circuit board 31′ and a printed circuit board 32′, wherein the focus coil 3f and tilt coils 3ti are formed on the printed circuit board 31′, and the tracking coils 3tr are formed on the printed circuit board 32′. FIG. 8 shows four tracking coil 3ti are formed on the printed circuit board 32′, however, two tracking coil 3ti may be formed on the printed circuit board 32′. In these case as well, the printed circuit boards may be laid one on top of another symmetrically right and left when they are viewed from the tracking direction T, thus being able to avoid resonance by possibly caused when the drive points are not coincident.

The one-end portions of the four conductive elastic members 104 are respectively fixed by solder (not shown) to the support pieces 112 of the lens holder 101 with the coil units 103 fixed thereto. Two lead wires are necessary to drive the focus coils, two lead wires are necessary to drive the tracking coils, and two lead wires are necessary to drive the tilt coils, that is, a total of six lead wires are necessary. Here, four units of such conductive elastic member 104 are enough to elastically support the lens holder 101 serving as the movable part. Here, the conductive elastic members 104 can also be used as lead wires. Therefore, the four conductive elastic members 104 are used as four of the six lead wires, while other lead wires (not shown) are connected to the remaining coils.

The two coil units 103 are respectively arranged in the two magnetic gaps 105g, while the other-end portions of the conductive elastic members 104 are respectively penetrated through a wire base 108 and are fixed to a base plate 109 by soldering. Due to this, the focus coil 103f, tracking coils 103tr and tilt coils 103ti mounted on the coil unit 103 can be disposed within the magnetic gap 105g and, at the same time, the movable part including the lens holder 101 holding the objective lens 2 is supported in a cantilevered manner so as to be movable with respect to the fixed part which includes the magnet 105, yoke base 106, yoke 7, wire base 108 and base plate 109.

The structures of the magnetic circuits employed in the apparatus shown in FIG. 20 as well as the arrangements and operations of the focus coils, tracking coils and tilt coils used in the coil units of the apparatus shown in FIG. 20 are similar to the previously described first embodiment and thus the description thereof is omitted here (see FIGS. 2 to 4).

As described above, according to the present embodiment, there are completed two magnetic circuits each including at least one magnet 105 magnetized in two polarities, and, within the magnetic gap 105g of each of the two magnetic circuits 105, there are disposed not only the focus coil 103f and tracking coils 103tr but also the tilt coils 103ti. Thanks to this, not only focus servo and tracking servo but also tilt servo (that is, the adjustment of the inclination of the objective lens 102) can be attained. Therefore, there is eliminated the need for provision of a magnet which is exclusively used to adjust the inclination of the objective lens 102. This can reduce the number of parts, can adjust the inclination of the objective lens 102 at a low cost, and can reduce the size of the whole objective lens drive apparatus.

The above description relates to the structure in which the two tilt coils 103ti are respectively disposed right and left (in the tracking direction T) with respect to the center of the printed circuit board 132. However, similarly to the first embodiment, even in case where the two tilt coils 103ti are respectively disposed upwardly and downwardly (in the focus direction F) of the center of the printed circuit board 132, there can be obtained a similar effect. In this case, the structure of the magnetic circuit and the operation of the coil unit are similar to the first embodiment and thus the description thereof is omitted here (see FIGS. 5 to 7).

Further, as well as the first embodiment, four tracking coils 103tr may be formed on the printed circuit board 131, and one focus coil 103f and two tilt coils 103ti may be formed on the printed circuit board 132. (see FIGS. 8 and 9)

Furthermore, in this embodiment, the magnet 5 has two poles magnetized in the focus direction F or in the tracking direction T. However, as well as the first embodiment, the coils may be disposed in the magnetic gap defined by the two-pole magnetized magnet using a U shape, the three-pole magnetized magnet and the four-pole magnetized magnet. (see FIGS. 11 to 19)

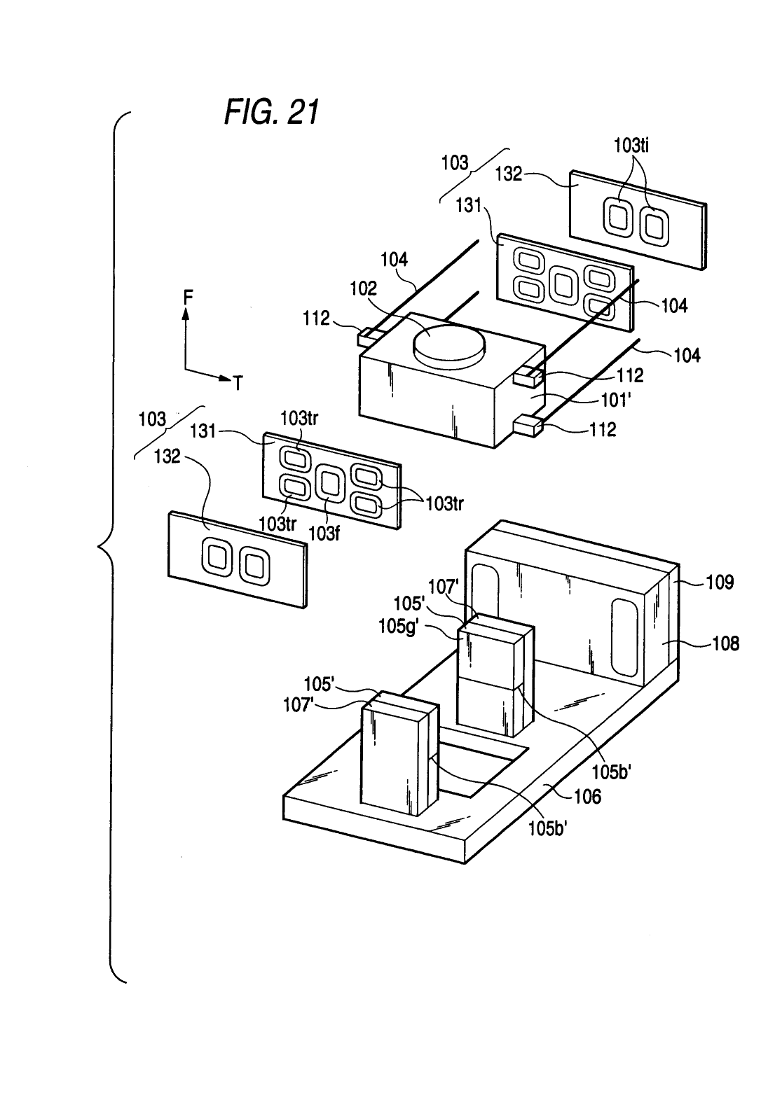

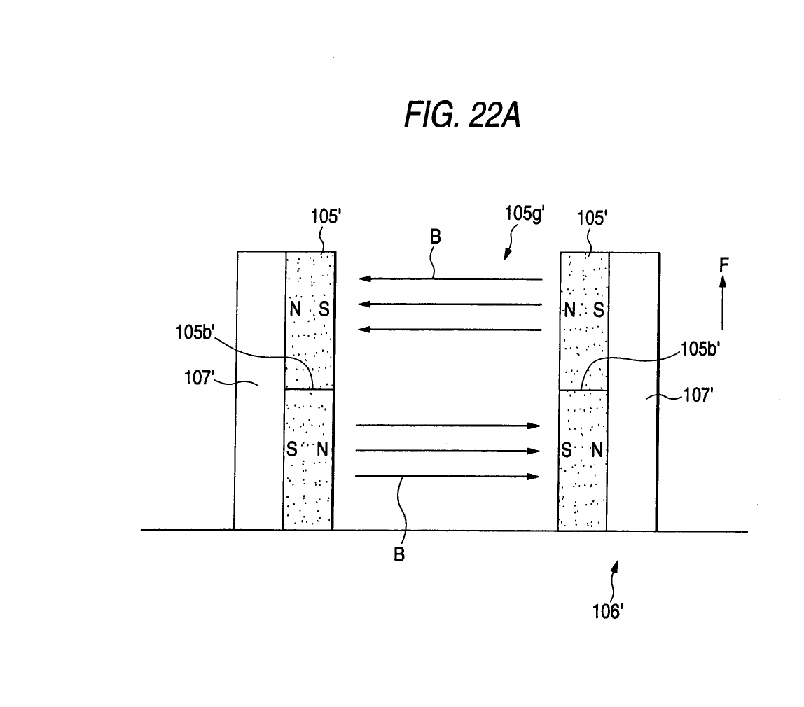

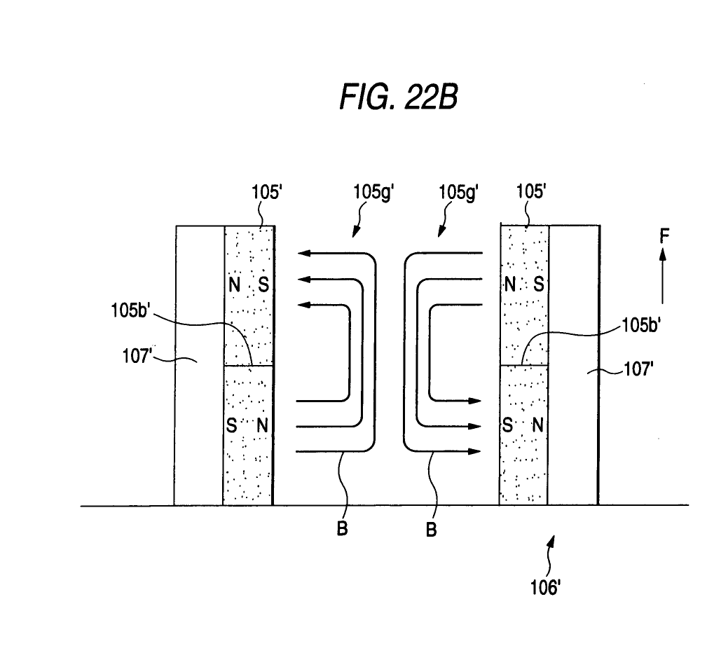

By the way, as shown in FIG. 21, two magnetic circuits may respectively include one magnet 105′. In this case, magnets 105′ and yokes 107′ are respectively provided outside of a lens holder 101′ with respect to the center of the lens holder 101′. In this structure, the slit 111 need not be provided in the lens holder 101′, therefore, the whole objective lens drive apparatus can be made compact. The magnetic circuit in this case is shown in FIG. 22 or 22B. Here, the magnetic gap means an air gap or air path. In FIG. 22A, the magnetic gap 105g′ is formed by two magnets, and in FIG. 22B, the magnetic gaps 105g′ are respectively formed by each magnet. Although FIGS. 22A and 22B show a magnetic circuit including two-pole magnetized magnet 105′, however, a two-pole magnetized magnet using a U shape, a three-pole magnetized magnet and a four-pole magnetized magnet may be applied to the magnetic circuit.

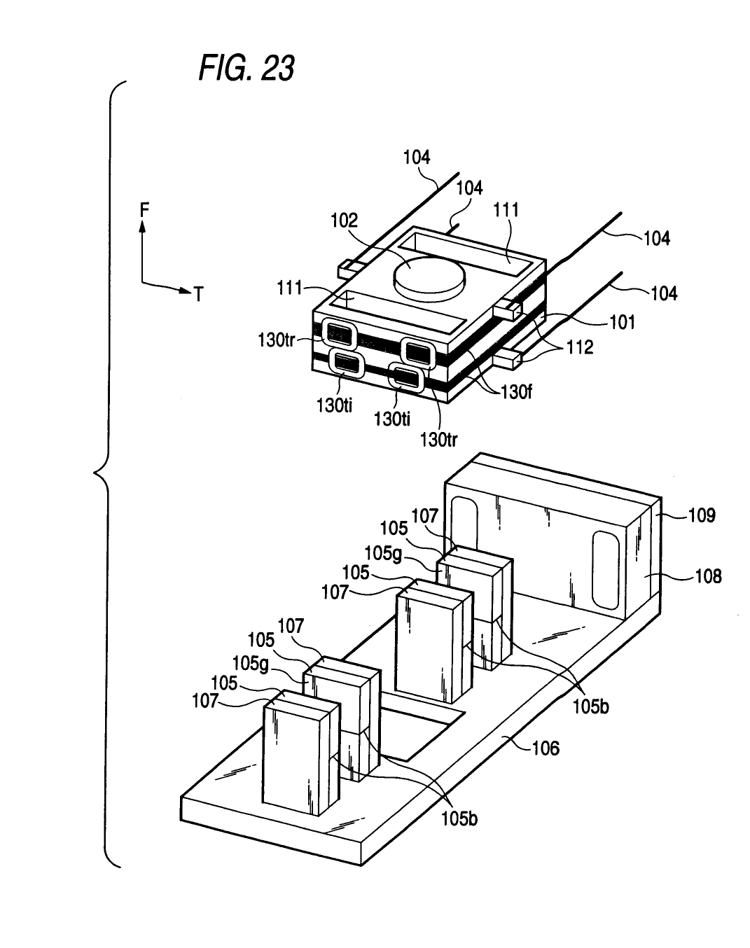

In the above structure, the coil units 103 are bonded and fixed to the pair of side surfaces of the lens holder 101 that extend in parallel to the tracking direction. However, a similar effect can also be obtained even in another structure in which, as shown in FIG. 23, there are completed two magnetic circuits each including at least one magnet 105 magnetized in two polarities in the focus direction F and, within each of the magnetic gaps 105g of the magnetic circuits, there are disposed focus coils 130f respectively wound around the side surfaces of the lens holder 101 as well as the tracking coils 130tr and tilt coils 130ti respectively mounted on the two side surfaces (which extend in parallel to the tracking direction T) of the lens holder 101. By the way, two magnetic circuit may be respectively include one magnet, as shown in FIG. 21.

Each focus coil 130f is a winding coil with the lens holder 101 as its winding frame and thus, when compared with a focus coil which is pattern formed on a printed circuit board, the focus coil 130f is easy to manufacture.

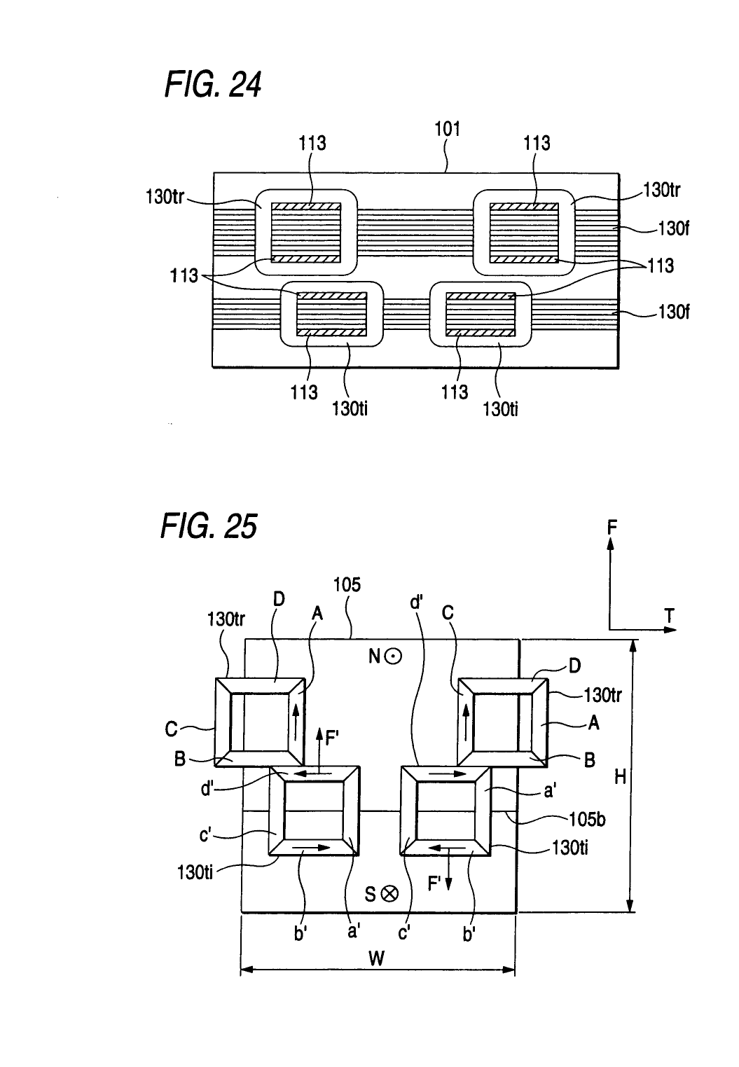

The tracking coil 130tr and tilt coil 130ti are respectively a coreless coil which is mounted on top of the focus coil 130f. However, the tracking coil 130tr and tilt coil 130ti may also be pattern formed on a printed circuit board. Also, the tracking coils 130tr and tilt coils 130ti may also be winding coils in which, as shown in FIG. 24, coil winding frames 113 are provided on and projected from the side surfaces (which extend in parallel to the tracking direction T) of the lens holder 101 and coils are respectively wound around these coil winding frames 113. Further, one of the tracking coil 130tr and tilt coil 130ti may be mounted on the focus coil 130f and the other may be wound around the coil winding frame 113.

The magnet 105 is magnetized in two polarities in the focus direction F by the boundary line 105b between the N and S poles of the magnet 105 and is bonded to the yoke 107 which is disposed on a yoke base 106.

The width W of the magnet 105 is determined such that, when, at the movable neutral position of the movable part movably supported in a cantilevered manner by the conductive elastic members 104, that is, at the self-weight position of the movable part in the focus direction F, as shown in FIG. 25, the lens holder 101 is arranged in the magnetic gap 105g, not only the right and left inner vertical sides A and C of the vertical sides A and C (which extend in parallel to the focus direction F) of the two tracking coils 130tr, which are disposed in the upper stage in the focus direction F as well as are disposed right and left in a row in the tracking direction T, but also the right and left outer vertical sides a′ and c′ of the vertical sides a′ and c′ (which extend in parallel to the focus direction F) of the two tilt coils 130tr which are disposed in the lower stage in the focus direction F as well as are disposed right and left in a row in the tracking direction T can be respectively arranged within the magnetic gap 105g (which points out a gap existing within the width W of the two mutually opposing magnets 105). Also, the height H of the magnet 105 is determined such that, as shown in FIG. 25, the horizontal sides B and D (which extend perpendicularly to the focus direction F) of the tracking coils 130tr as well as the horizontal sides b′ and d′ (which extend perpendicularly to the focus direction F) of the tilt coils 130ti can be respectively disposed within the magnetic gap 105g (which points out a gap existing within the height H of the two mutually opposing magnets 105).

The boundary line 105b between the N and S poles of the magnet 105, as shown in FIG. 25, is situated downwardly of the lower sides B of the horizontal sides B and D (which extend perpendicularly to the focus direction F) of the tracking coils 130tr as well as midway between the lower sides b′ and upper sides d′ of the horizontal sides b′ and d′ (which extend perpendicularly to the focus direction F) of the tilt coils 130ti. The center of the magnet 105 is substantially coincident with the center of the lens holder 101.

The focus coils 130f are disposed upwardly and downwardly with the boundary line 105b between the N and S poles of the magnet 105 as the boundary line thereof. The upper and lower focus coils 130f are connected in series, while the directions of the currents of the upper and lower focus coils 130f are reversed. The directions of magnetic lines of force in the two magnetic gaps 105g are reversed.

In FIGS. 23 and 24, all sides of the tracking coils 130tr and tilt coils 130ti are mounted on one side surface (which extends in parallel to the tracking direction T) of the lens holder 1. However, this is not limitative but it is also possible to employ another structure; that is, the sides that are arranged within the magnetic gap 105g and are able to generate drive forces, for example, the vertical sides A, C (see FIG. 25) (which extend in parallel to the focus direction F) of the tracking coils 130tr, which, in case where currents are allowed to flow in the tracking coils 130tr, can generate drive forces in the same direction in the tracking direction T, are mounted on one side surface of the lens holder 1.

The lens holder 101 is disposed in the two magnetic gaps 105g and the other-side ends of the conductive elastic members 104 are penetrated through a wire base 108 and are fixed to a base plate 109 by soldering. Thanks to this, the focus coils 130f, tracking coils 130tr and tilt coils 130ti can be disposed within the magnetic gap 105g and, at the same time, the movable part including the lens holder 101 holding the objective lens 102 can be supported in a cantilevered manner so as to be movable with respect to the fixed part which includes the magnet 5, yoke base 106, yoke 107, wire base 108 and base plate 109.

In FIG. 23, in case where currents are allowed to flow in the focus coils 130f, due to the current that flows in the magnetic gap 105g, in the focus coils 130f, there are generated drive forces in the focus direction F according to Fleming's left-hand rule.

In FIG. 25, in case where current are allowed to flow in the tracking coils 130tr, due to the currents (shown by arrow marks) that flow in the vertical sides A and C (which extend in parallel to the focus direction F) of the tracking coils 130tr, in the two tracking coils 130tr, there are generated drive forces in the same direction in the tracking direction T according to Fleming's left-hand rule; and, in case where currents are allowed to flow in the tilt coils 130ti, due to the currents (shown by arrow marks) that flow in the horizontal sides b′ and d′ (which extend perpendicularly to the focus direction F) of the tilt coils 130ti, in the two tilt coils 130ti, there are generated drive forces F′ in the mutually reversed directions in the focus direction F according to Fleming's left-hand rule. Due to the reversed-direction drive forces F′, there is generated moment around the center of gravity of the movable part, thereby being able to adjust the inclination of the lens holder 101 and thus the inclination of the objective lens 102.

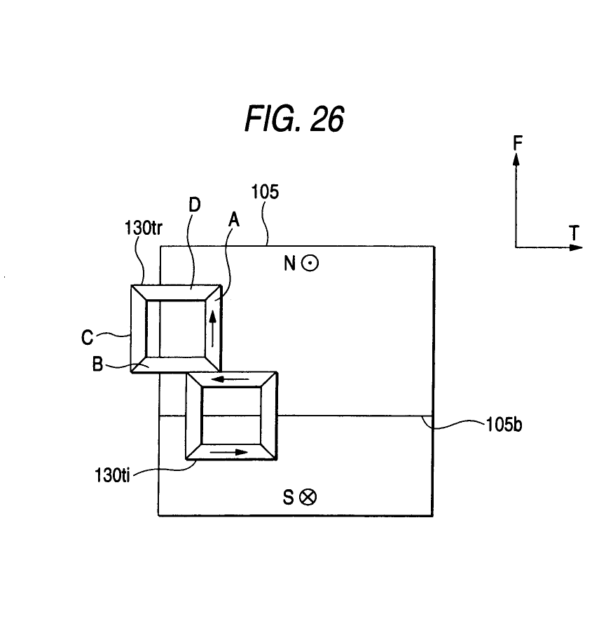

The above description relates to the structure in which the two tracking coils 130tr and two tilt coils 130ti are arranged right and left symmetrically in the tracking direction T, while there are generated the drive forces in the same direction in the two tracking coils 130tr and there are generated drive forces in the reversed directions in the two tilt coils 130ti. However, as shown in FIG. 26, the vertical side A (which extends in parallel to the focus direction F) of a tracking coil 130tr may be disposed within the width W of the magnet 105, and the vertical side C (which extends in parallel to the focus direction F) of the tracking coil 130tr may be disposed outside the width W of the magnet 105; and, at the same time, a tilt coil 130ti may be disposed shifted outside with respect to the center of the magnet 105 in the tracking direction T. Also, instead of the tracking coil 130tr, as shown in FIG. 25, there may be used two tracking coils 130tr; and, instead of the tilt coil 130ti, as shown in FIG. 26, there may be used two tilt coils 130ti. Further, the tracking coil 130tr, as shown in FIG. 26, may be one in number and the tilt coil 130ti, as shown in FIG. 25, may be two in number. In any of these structures, the weight of the objective lens drive apparatus can be reduced.

### Embodiment 3

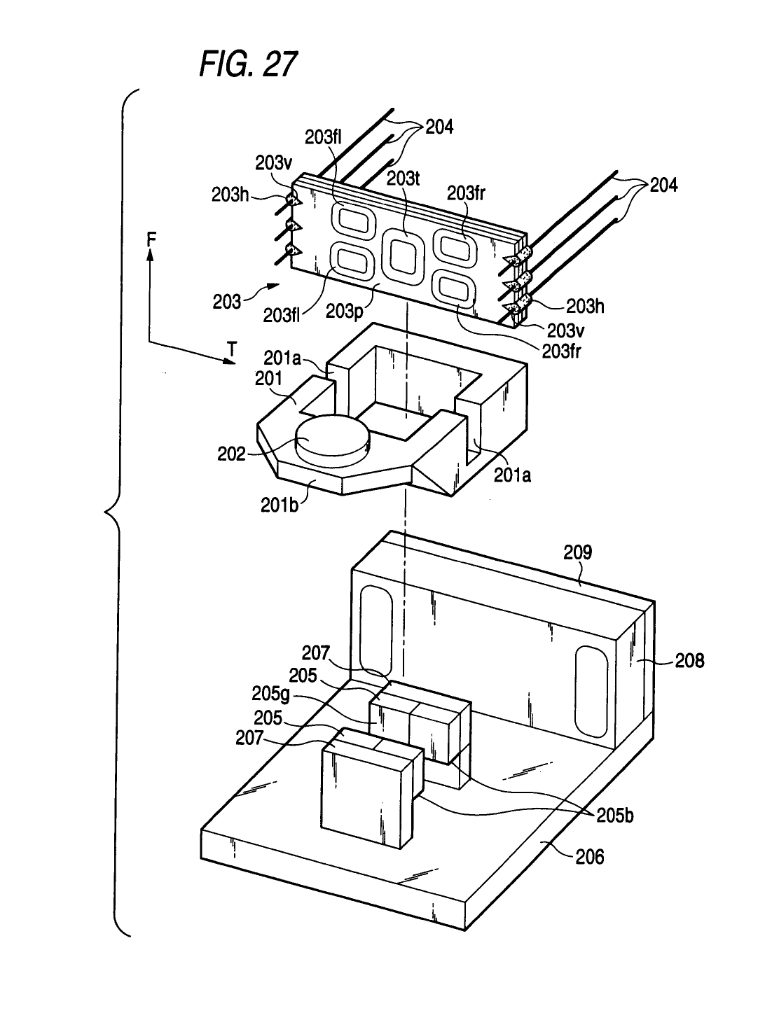

Now, FIG. 27 is a perspective view of a third embodiment of an objective lens drive apparatus according to the invention.

In FIG. 27, reference character 201 designates a lens holder, 202 an objective lens, 203 a coil unit, and 205 a magnet, respectively.

The lens holder 201 is similar in structure to the lens holder 1 employed in the previously described first embodiment.

The coil unit 203 comprises a required number of printed circuit boards 203p which are laminated one on top of another, while each of the printed circuit board 203p comprises a tracking coil 203t and four focus coils 203fl and 203fr. The tracking coil 203t is situated at the center of the printed circuit board 203p, while the focus coils 203fl and 203fr are arranged in two upper and lower stages and are disposed right and left with respect to the position of the objective-lens-optical-axis-direction center of gravity of a movable part including the lens holder 201 holding the objective lens 202, that is, on the right and left sides of the tracking coil 203t. The number of the focus coils 203fl and the number of the focus coils 203fr may also be one respectively. And, since currents are supplied to the left and right focus coils 203fl and 203fr individually, the left and right focus coils 203fl and 203fr are not connected in series but they are independent of each other.

The foregoing description relates to the structure in which the left and right focus coils 203fl, 203fr and tracking coil 203t are disposed on the same printed circuit board 203p. However, as a modification of the third embodiment, the left and right focus coils 203fl, 203fr and tracking coil 203t may also be disposed separately on two printed circuit boards. In this modification as well, the number of focus coils to be disposed on a printed circuit board is even and the number of tracking coils to be disposed on a printed circuit board is one.

The coil unit 203 is inserted into and bonded to the notch portions 201a of the lens holder 201 and is thereby fixed to the lens holder 201. In the two ends (in the tracking direction T) of the coil unit 203, there are formed six V-grooves 203v, while the one-side ends of six conductive elastic members 204 are respectively fixed to the six V-grooves 203v by solders 203h. The conductive elastic members 204, which are used as lead wires, consist of four members 204 (2×2) for focus coil driving and two members 204 for tracking coil driving, a total of six members 204.

By the way, four conductive elastic members 204 are enough to elastically hold the lens holder 201 serving as the movable part and, therefore, in case where four conductive elastic members 204 are employed to hold the lens holder 201, lead wires (not shown) are to be connected to the remaining coils.

The magnetic circuit employed in the present embodiment is similar to the magnetic circuit employed in the first embodiment and shown in FIG. 6. Further, the magnetic circuit may be include one magnet, as shown in FIGS. 9 and 10. In this case, the boundary line between the N and S poles is situated at the center of the magnet 5 in the tracking direction T as well as FIG. 6. Due to this, the whole objective lens drive apparatus can be made compact.

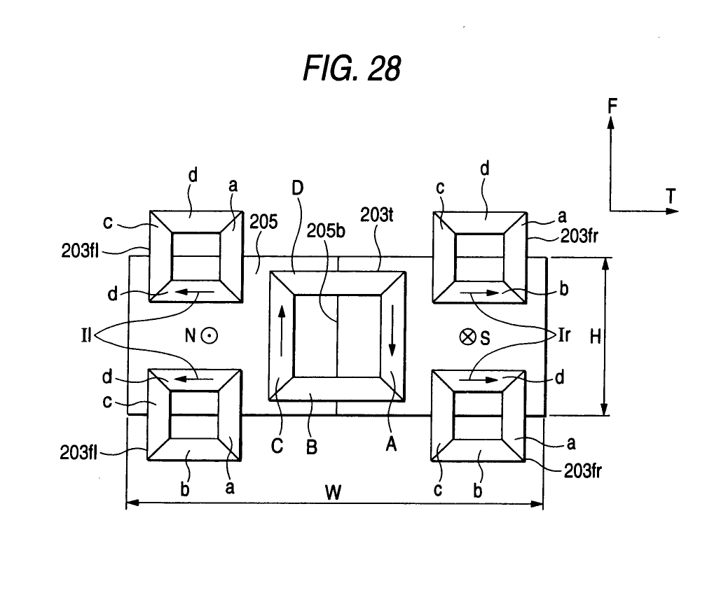

The width W of the magnet 205 is determined such that, at the movable neutral position of the movable part movably supported in a cantilevered manner by the conductive elastic members 204, that is, at the self-weight position of the movable part in the focus direction F, as shown in FIG. 28, when the coil unit 203 is arranged within the magnetic gap 205g, the right and left outer vertical sides c and a (which extend in parallel to the focus direction F) of the vertical sides a and c of the left focus coils 203fl in the two upper and lower stages as well as the right focus coils 203fr in the two upper and lower stages can be respectively disposed within the magnetic gap 205g (which points out a gap existing within the width W of the mutually opposing magnets 205). Also, the height H of the magnet 205 is determined such that, as shown in FIG. 28, the lower sides b of the horizontal sides b and d (which extend perpendicularly to the focus direction F) of the upper-stage focus coils 203fl and 203fr, the upper sides d (which extend perpendicular to the focus direction F) of the lower-stage focus coils 203fl and 203fr, and the horizontal sides B and D (which extend perpendicularly to the focus direction F) of the tracking coil 203t can be respectively disposed within the magnetic gap 205g (which points out a gap existing within the height W of the mutually opposing magnets 205).

The boundary line 205b between the N and S poles of the magnet 205, as shown in FIG. 28, is situated midway not only between the vertical sides A and C (which extend in parallel to the focus direction F) of the tracking coil 203t but also between the right sides a of the vertical sides a, c (which extend in parallel to the focus direction F) of the left focus coils 203fl and the left sides c of the vertical sides a, c (which extend in parallel to the focus direction F) of the right focus coils 203fr. The center of the magnet 205 is substantially coincident with the center of the coil unit 203.

The coil units 203 are respectively disposed within the magnetic gap 205g and the other-side ends of the conductive elastic members 204 are respectively penetrated through the wire base 208 and are fixed to the base plate 209 by soldering. In this manner, the focus coils 203fl, 203fr and tracking coil 203t mounted on the coil unit 203 are disposed within the magnetic gap 205g and, at the same time, the movable part including the lens holder 201 supporting the objective lens 202 is supported in a cantilevered manner so as to be movable with respect to the fixed part which includes the magnets 205, yoke base 206, yokes 207, wire base 208, and base plate 209.

The inclination of the optical disk can be detected using an inclination detect sensor which is separately prepared, or using a reproduction signal given by an optical pickup.

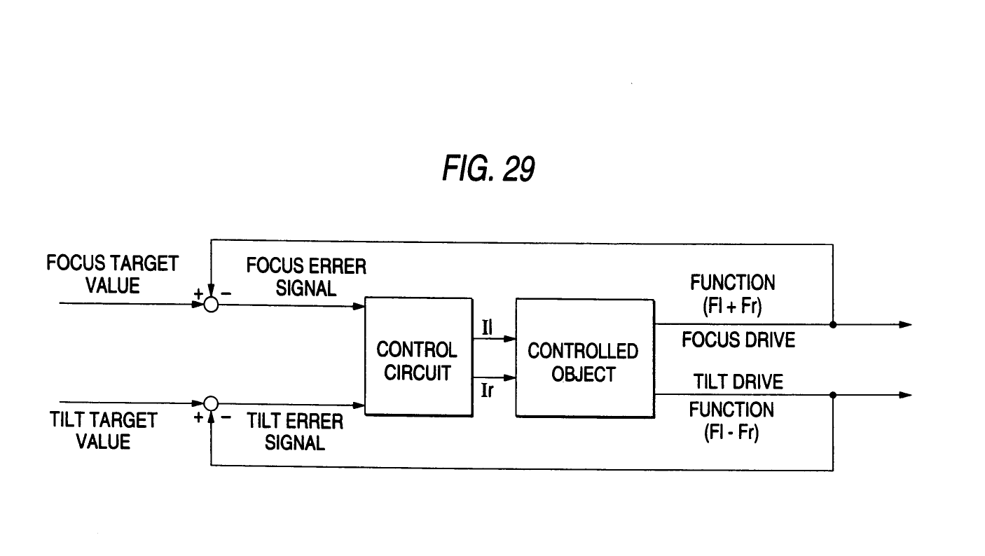

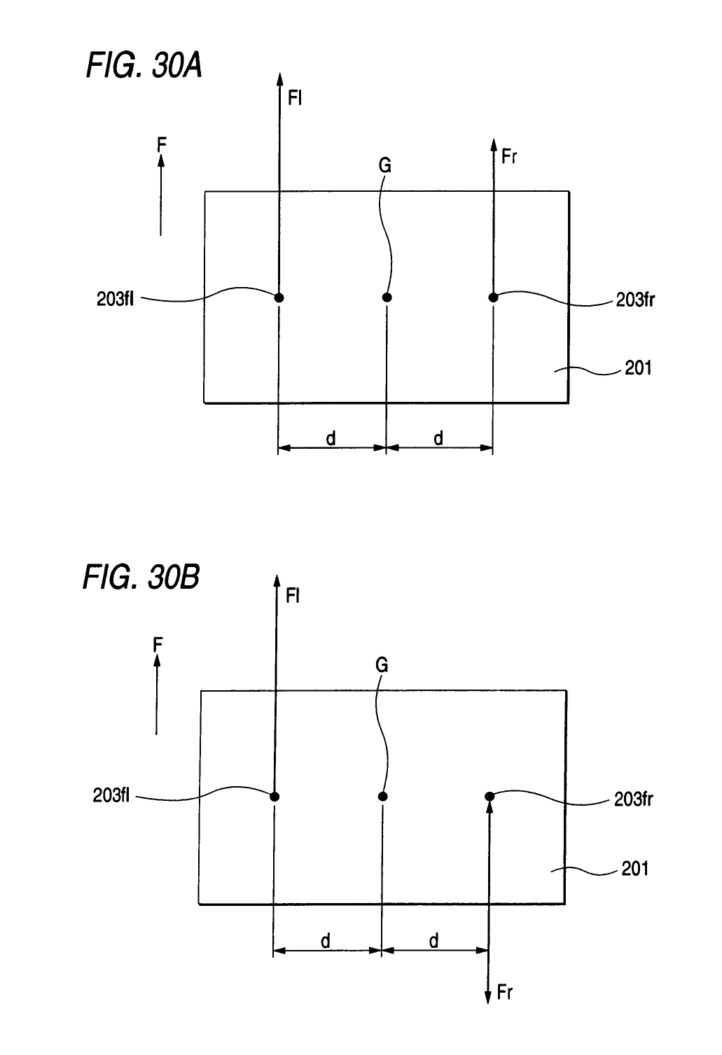

A tilt error signal and a focus error signal, which have been obtained using the inclination detect sensor or using the reproduction signal of the optical pickup, are input to a control circuit shown in FIG. 29; and, the control circuit calculates the optimum currents Il and Ir which can urge the focus coils 203fl and 203fr shown in FIG. 28 to thereby correct the focus error and tilt error at the same time, and then the control circuit outputs the thus calculated currents Il and Ir. The objective lens drive apparatus, which is a controlled object, not only executes a focus servo due to a force which is the sum of drive forces Fl and Fr generated in response to the currents Il and Ir and shown in FIG. 30A and also which moves in the focus direction F, but also executes a tilt servo due to the moment M=Fl×d−Fr×d that is generated around the center of gravity G of the lens holder 201 due to the difference between the drive forces Fl and Fr. Here, d expresses the distance between the center of gravity G of the lens holder 201 and the focus coils 203fl, 203fr.

Now, FIG. 30B shows a case in which, differently from FIG. 30A, the drive forces Fl and Fr are generated in the mutually opposite directions. In this case, a force, which is going to move in the focus direction F, is Fl+(−Fr), while a tilt is Fl×d−(−Fr×d). At any rate, the objective lens drive apparatus executes a focus driving operation with a function of (Fl+Fr) and executes a tilt driving operation with a function of (Fl−Fr).

The left and right focus coils 203fl and 203fr not only can execute focus servo but also can adjust the inclination of the objective lens 202. Therefore, there is eliminated the need for provision of a coil and a magnet which are exclusively used to adjust the inclination of the objective lens 202. This can reduce the number of parts, can adjust the inclination of the objective lens 202 at a low cost, and can reduce the size of the whole objective lens drive apparatus.

In case where the tracking coil 203 is urged, due to the currents (shown by arrow marks in FIG. 28) that flow in the vertical sides A and C (which extend in parallel to the focus direction F) of the tracking coil 203t, there are generated drive forces in the same direction in the tracking direction T, so that the objective lens 202 can be moved in the tracking direction T according to the eccentricity of a record medium.

In case where the coil unit 203 is inserted into and bonded to the notch portions 201a of the lens holder 201, the number of magnetic gaps 205g can be reduced down to one. This can also reduce the number of parts, can adjust the inclination of the objective lens 202 at a low cost, and can reduce the size of the whole objective lens drive apparatus.

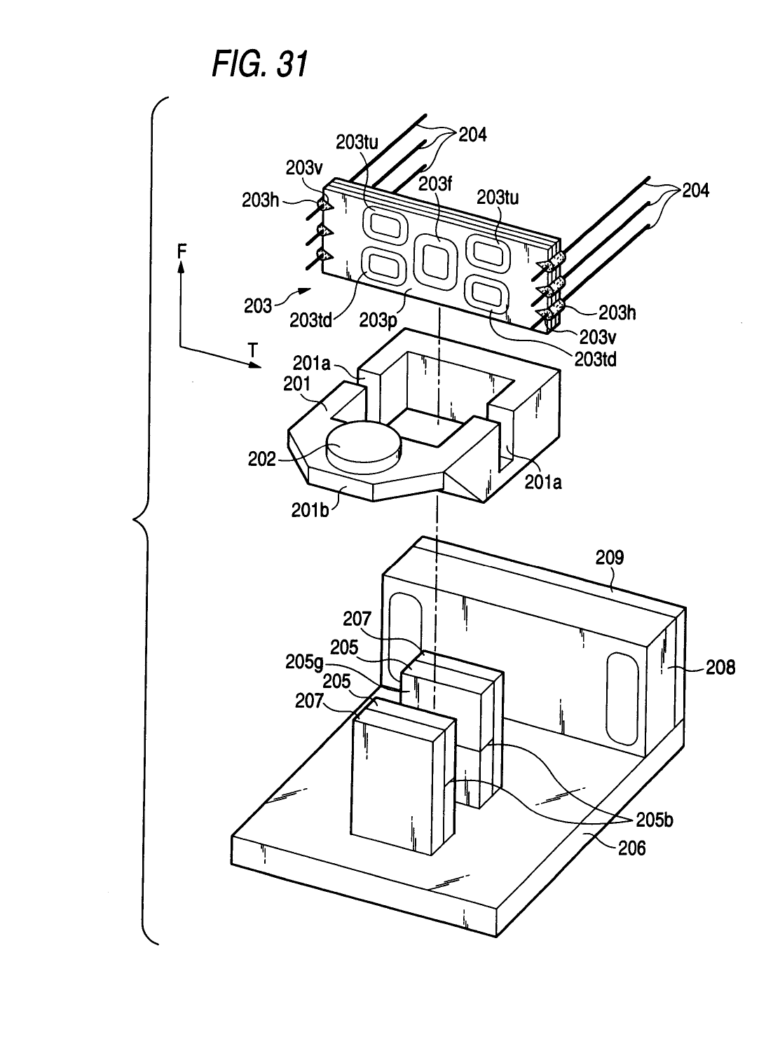

In the above-mentioned embodiment, not only the focus servo but also the adjustment of the inclination of the objective lens 202 are carried out using the left and right focus coils 203fl and 203fr. However, a similar effect can also be obtained in the following structure: that is, as shown in FIG. 31, a coil unit 203 comprises a required number of printed circuit boards 203p which are laid one on top of another, while each of the printed circuit boards 203p includes a focus coil 203f and four tracking coils 203t; the focus coil 203f is arranged at the center of each printed circuit board 203p; the tracking coils 203tu and 203td are respectively disposed upwardly and downwardly of the objective-lens-optical-axis-direction center of gravity of a movable part including a lens holder 201 holding an objective lens 202, that is, the tracking coils 203tu and 203td are disposed in two right and left rows respectively extending upwardly and downwardly of the focus coil 203f; and, a magnet 205 is magnetized in two polarities in the focus direction by the boundary line 205b between the N and S poles of the magnet 205. In this structure, a magnetic circuit is similar to the magnetic circuit that is employed in the first embodiment and is shown in FIG. 2. By the way, the magnetic circuit may include one magnet 5′ as shown in FIG. 9, and the coil unit may be disposed in the air gap 5g′. The magnetic circuit is shown in FIG. 10, similar operation of coils when the magnetic circuit includes two magnets and the magnetic gap as described above can be obtained.

Here, alternatively, the tracking coils 203tu and 203td may also be one in number respectively. Since currents are supplied to the upper and lower tracking coils 203tu and 203td individually, they are not connected in series but are connected independent of each other.

In this structure, the focus coil 203f and tracking coils 203tu, 203td are disposed on the same printed circuit board 203p. However, the focus coil 203f and tracking coils 203tu, 203td may also be disposed separately on two different printed circuit boards. In this case as well, the numbers of focus coils and tracking coils to be disposed on a printed circuit board are respectively one and even.

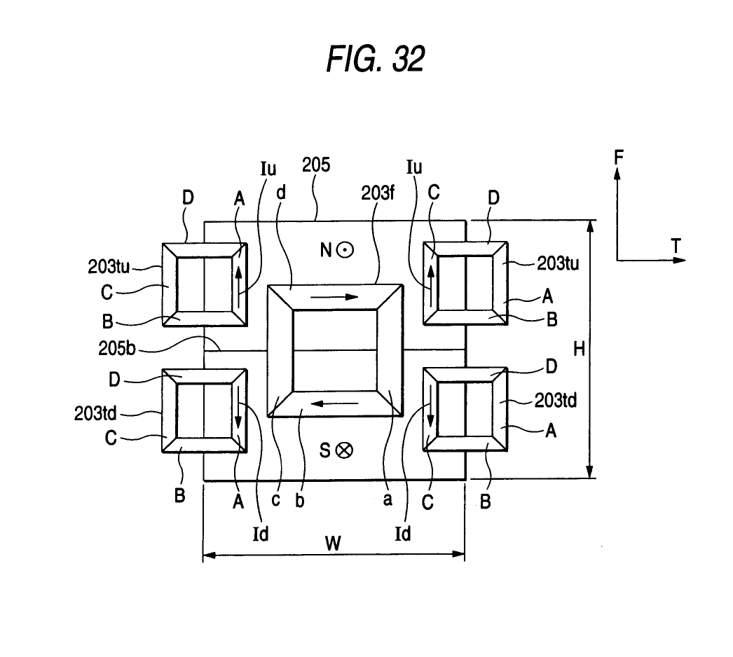

The width W of the magnet 205 is determined such that, at the movable neutral position of the movable part movably supported in a cantilevered manner by the conductive elastic members 204, that is, at the self-weight position of the movable part in the focus direction F, as shown in FIG. 32, when the coil unit 203 is arranged within the magnetic gap 205g, the right and left inner vertical sides C and A of the vertical sides A and C (which extend in parallel to the focus direction) of the two upper-stage right and left tracking coils 203tu as well as the two lower-stage right and left tracking coils 203td can be respectively disposed within the magnetic gap 205g (which points out a gap existing within the width W of the mutually opposing magnets 205). Also, the height H of the magnet 205 is determined such that, as shown in FIG. 32, not only the horizontal sides b and d (which extend perpendicularly to the focus direction F) of the focus coil 203f situated at the center of the print circuit board 203p, but also the upper sides D of the horizontal sides B and D (which extend perpendicularly to the focus direction F) of the upper-stage tracking coils 203tu and the lower sides B of the horizontal sides B and D (which extend perpendicularly to the focus direction F) of the lower-stage tracking coil 203td can be respectively disposed within the magnetic gap 205g (which points out a gap existing within the height W of the mutually opposing magnets 205).

The boundary line 205b between the N and S poles of the magnet 205, as shown in FIG. 32, is situated midway not only between the lower side b and upper side d of the horizontal sides b and d (which extend perpendicularly to the focus direction F) of the focus coil 203f but also between the lower sides B of the horizontal sides B and D (which extend perpendicularly to the focus direction F) of the upper-stage tracking coils 203tu and the upper sides D of the horizontal sides B and D (which extend perpendicularly to the focus direction F) of the lower-stage tracking coils 203td. And, the center of the magnet 205 is substantially coincident with the center of the coil unit 203.

A tilt error signal and a tracking error signal, which have been obtained using an inclination detect sensor or using the reproduction signal of an optical pickup, are input to a control circuit which is similar to the control circuit shown in FIG. 29; and, the control circuit calculates the optimum currents Iu and Id which can urge the tracking coils 203tu and 203td shown in FIG. 32 to thereby correct the tracking error and tilt error at the same time, and then the control circuit outputs the thus calculated currents Iu and Id. The objective lens drive apparatus, which is an controlled object, not only executes a tracking servo due to a force which is the sum of driving forces (not shown) generated in response to the currents Iu and Id and also which moves in the tracking direction F, but also executes a tilt servo due to the moment that is generated around the center of gravity of the lens holder 201 due to the difference between the driving forces.

In case where the focus coil 203f is urged, due to the currents (shown by arrow marks in FIG. 32) that flow in the horizontal sides b and d which extend perpendicularly to the focus direction F of the focus coil 203f in FIG. 32, there are generated driving forces in the same direction in the focus direction F, so that the objective lens 202 can be moved in the focus direction F according to the surface vibration of the record medium.

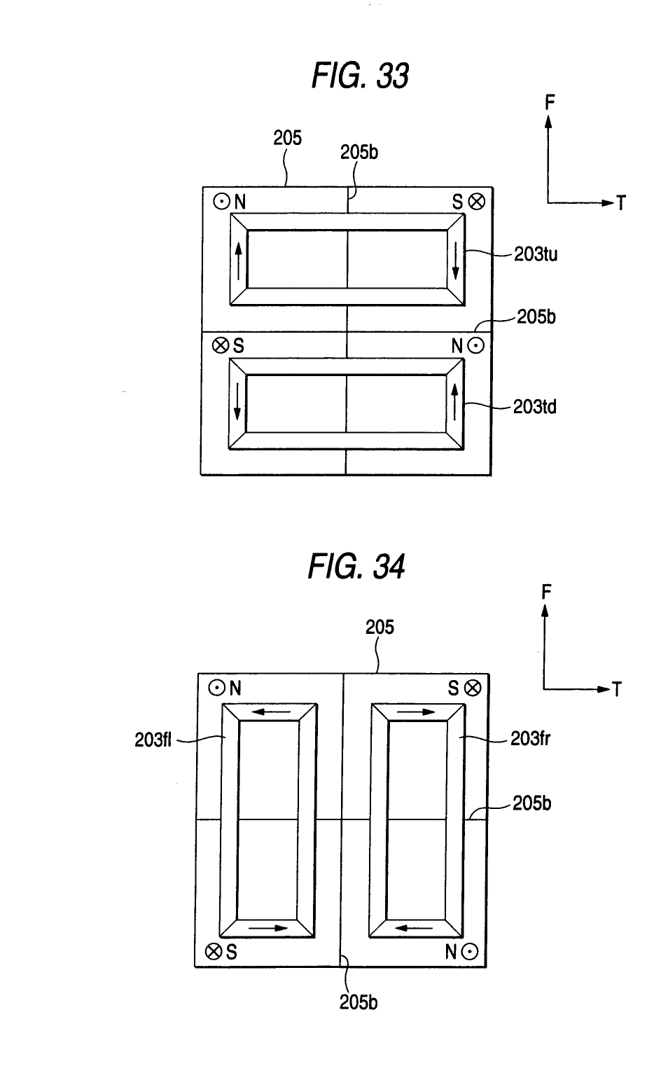

In this embodiment, the magnet 205 has two poles magnetized in the focus direction F or in the tracking direction T. However, this is not limitative but, for example, as shown in FIG. 33, there can also be employed a magnet 205 including two magnet sections each having two poles magnetized in the tracking direction and respectively disposed in upper and lower stages in the focus direction, thereby providing the magnet 205 having four poles magnetized. In this case, as shown in FIG. 33, two tracking coils 203tu are disposed in the upper and lower portions of the magnet 205, that is, in the first and second quadrants of the magnet 205 and in the third and fourth quadrants of the magnet 205; and, currents having mutually opposite directions are allowed to flow through the two tracking coils 203tu and, due to the force that is the sum of the upper and lower drive forces Fu and Fd respectively generated in the two tracking coils 203tu and moves in the tracking direction T, there can be carried out a tracking servo control. Also, as shown in FIG. 34, two focus coils 203fl, 203fr are disposed in the right and left portions of the magnet 205, that is, in the first and fourth quadrants of the magnet 205 and in the second and third quadrants of the magnet 205; and, left and right currents Il and Ir ideally suitable for simultaneous correction of focus errors and tilt errors output from the control circuit are allowed to flow through the two focus coils 203fl, 203fr, whereby a focus servo control is executed due to the force that is the sum of left and right drives forces Fl and Fr respectively generated in the two focus coils 203fl, 203fr and moves in the focus direction F and, at the same time, a tilt servo control is carried out due to the moment generated around the center of gravity G caused by the difference between the left and right forces Fl and Fr.

Also, although not shown, upper and lower currents Iu and Id ideally suitable for simultaneous correction of tracking errors and tilt errors output from the control circuit are allowed to flow through the upper and lower tracking coils 203tu, 203td respectively disposed in the first and second quadrants of the magnet 205 and in the third and fourth quadrants of the magnet 205, whereby a tracking servo control is executed due to the force that is the sum of upper and lower forces Fu and Fd respectively generated in the two tracking coils 203tu, 203td and moves in the tracking direction F and, at the same time, a tilt servo control is carried out due to the moment generated around the center of gravity G caused by the difference between the upper and lower forces Fu and Fd.

In case where the magnet 205 has four poles magnetized, when compared with the magnet having two poles magnetized, the number of coils is reduced from five down to four, thereby being able save the coils used. Also, in the case of the magnet 205 having two poles magnetized, the portions of the magnet 205, which are opposed to the portions where the coil drive forces are generated, must be disposed outside the magnetic gap 205g (that is, the b and d sides of 203fl and 203fr in FIG. 28; the A and C sides of 203tu and 203td in FIG. 32). On the other hand, in the case of the magnet 205 having four poles magnetized, it is not necessary that the above-mentioned opposed portions of the magnet 205 are disposed out side the magnetic gap 205g and, therefore, the coil arrangement is easy. Also, in case where the whole portion of coils are disposed within the magnetic gap 205g, the mutually opposed two sides always contribute toward the generation of the drive force, thereby being able to enhance the use rate of the coils.

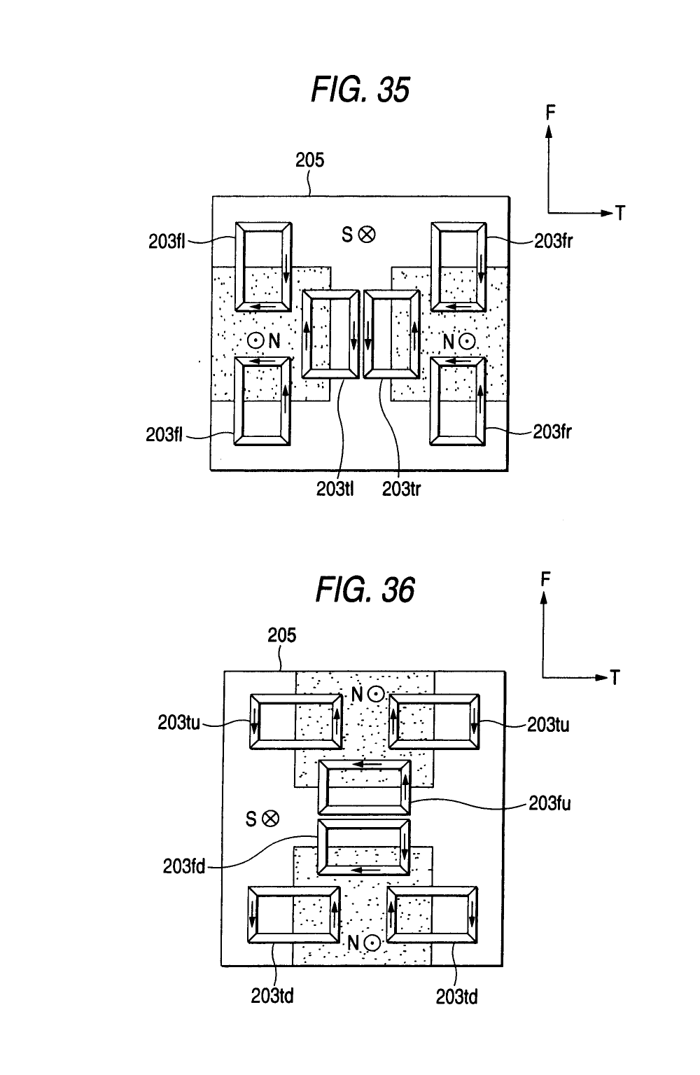

In this embodiment, the magnet 205 has two or four poles magnetized. However, the magnet 205 may also have three poles magnetized: that is, one pole (for example, S pole) is formed so as to have an I-shaped front surface and the other two poles (for example, N poles) each having a quadrilateral-shaped front surface are inserted into the other space of one pole to thereby provide a magnet having a quadrilateral-shaped front surface as a whole. In this case, as shown in FIG. 35, two tracking coils 203tr, 203tl are disposed in the right and left portions of the magnet 205, that is, in the web portions of the I-like shape and in the N poles and currents having mutually opposite directions are allowed to flow through the two tracking coils 203tr, 203tl, whereby the tracking servo is carried out due to the force that is the sum of the upper and drive forces Fu and Fd and moves in the tracking direction T. Also, as shown in FIG. 35, four focus coils 203fl, 203fr are disposed in the right, left, upper and lower portions of the magnet 205, that is, in the upper and lower portions of the flange portion of the I-like shape and in the N poles; and, left and right currents Il and Ir ideally suitable for simultaneous correction of focus errors and tilt errors output from the control circuit part are allowed to flow through the two focus coils 203fl, 203fr, whereby a focus servo control is executed due to the force that is the sum of left and right drives forces Fl and Fr respectively generated in the two focus coils 203fl, 203fr and moves in the focus direction F and, at the same time, a tilt servo control is carried out due to the moment generated around the center of gravity G caused by the difference between the left and right forces Fl and Fr.

When the magnet 205 is structured such that it has three poles magnetized, as shown in FIG. 36, one pole (for example, S pole) is formed so as to have an H-shaped front surface and the other two poles (for example, N poles) each having a quadrilateral-shaped front surface are inserted into the other space of one pole to thereby provide a magnet having a quadrilateral-shaped front surface as a whole. In this case, as shown in FIG. 36, two focus coils 203fu, 203fd are disposed in the upper and lower portions of the magnet 205, that is, in the web portion of the H-like shape and in the N poles and currents having mutually opposite directions are allowed to flow through the two focus coils 203fu, 203fd, whereby a focus servo control is carried out due to the force that is the sum of the upper and drive forces Fu and Fd and moves in the focus direction F. Also, as shown in FIG. 36, upper and lower currents Iu and Id ideally suitable for simultaneous correction of tracking errors and tilt errors output from the control circuit part are allowed to flow through the four tracking coils 203tu, 203td are disposed in the right and left portions of the flange portion of the H-like shape and in the N poles, whereby a tracking servo control is executed due to the force that is the sum of upper and lower drives forces Fu and Fd respectively generated in the tracking coils and moves in the tracking direction T and, at the same time, a tilt servo control is carried out due to the moment generated around the center of gravity G caused by the difference between the upper and lower forces Fu and Fd.

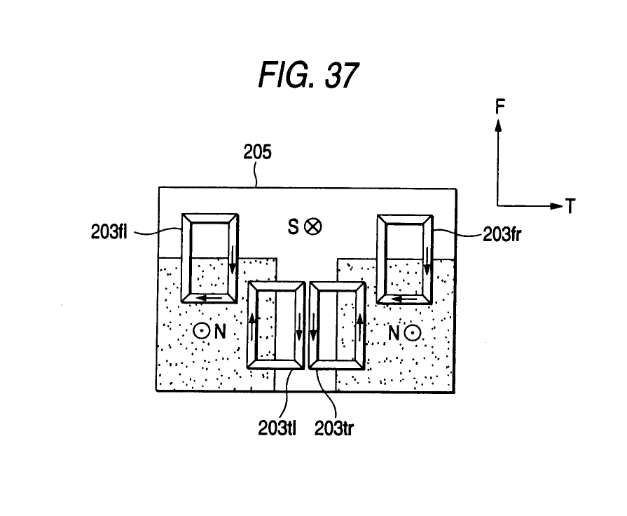

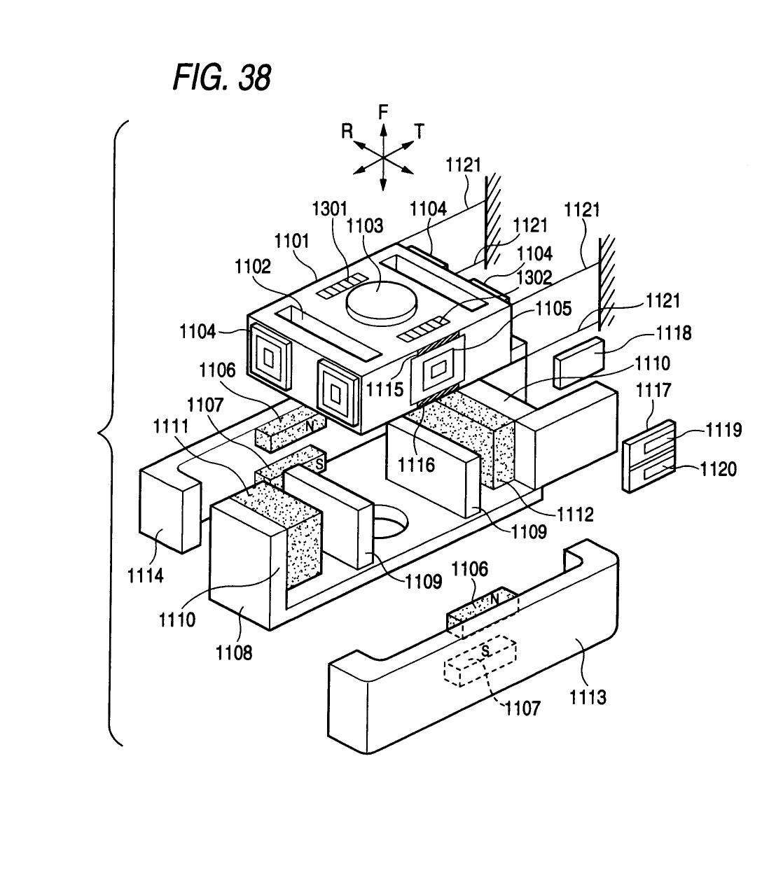

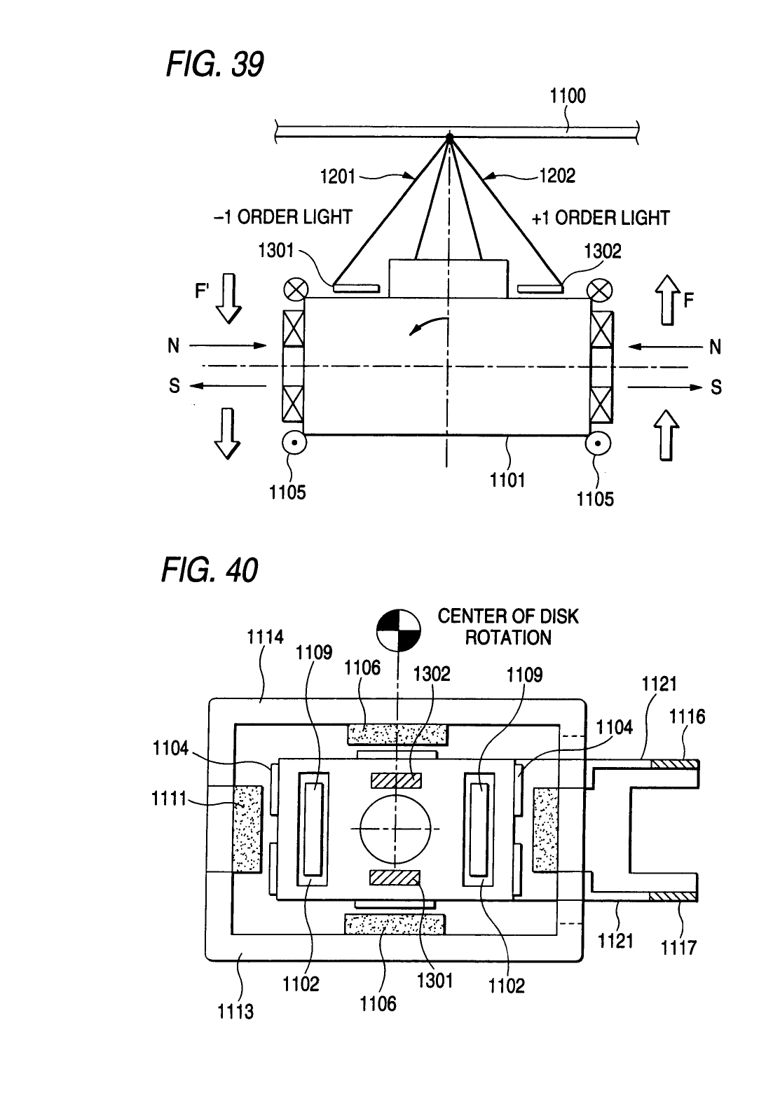

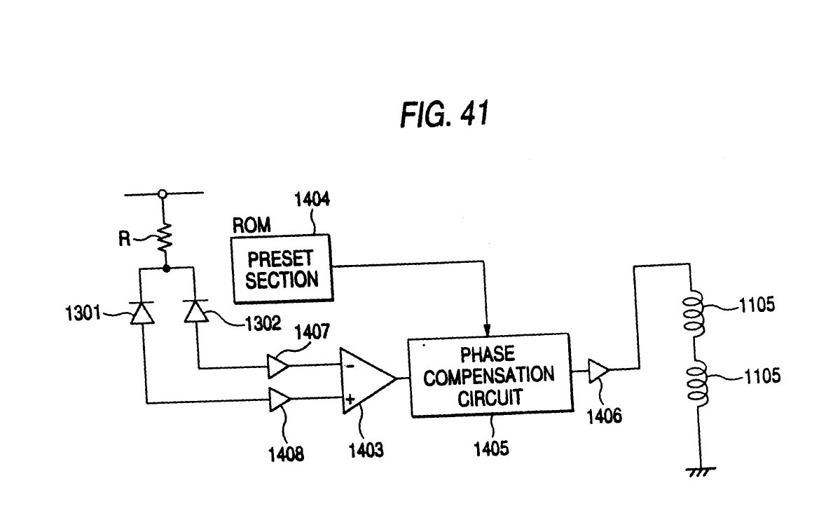

In this embodiment, the tilt servo is carried out using the four focus coils 203 for four tracking coils 203tr. However, when the tilt servo control is executed using two focus coils 203f, as shown in FIG. 37, there is used a magnet having three poles magnetized: that is, one pole (for example, S pole) is formed so as to have a T-shaped front surface and the other two poles (for example, N poles) each having a quadrilateral-shaped front surface are inserted into the other space of one pole to thereby provide a magnet having a quadrilateral-shaped front surface as a whole. In this case, two tracking coils 203tl, 203tr are disposed in the central portion of the magnet 205, that is, in the vertical portion of the T shape and in the N poles; and, two focus coils 203fl, 203fr are disposed in the left and right portions of the magnet 205, that is, in the horizontal portion of the T-like shape and in the N poles. And, left and right currents Il and Ir ideally suitable for simultaneous correction of focus errors and tilt errors output from the control circuit part are allowed to flow through the two focus coils 203fl, 203fr, whereby the focus servo control is executed due to the force that is the sum of left and right drives forces Fl and Fr respectively generated in the two focus coils 203fl, 203fr and moves in the focus direction F and, at the same time, the tilt servo control is carried out due to the moment generated around the center of gravity G caused by the difference between the left and right forces Fl and Fr.

In the case of the magnet having three poles magnetized, when compared with the magnet having two poles magnetized, similarly to the magnet having four poles magnetized, the use rate of the coils can be enhanced.

Referring to the coil unit, whether the magnet has three or four poles magnetized, similarly to the magnet having two poles magnetized, the coil unit includes a plurality of piled-up printed circuits of two types: that is, one type includes one or more focus coils 203f mounted thereon; and, the other type includes one or more tracking coils 203t mounted thereon. Also, the coil unit may also include a plurality of piled-up printed circuits each including one or more focus coils 203f and one or more tracking coils 203t mounted thereon.

Further, the system that can execute the tilt driving by the control unit having focus coil and tracking coil in the third embodiment can be applied to the objective lens drive apparatus according the second embodiment shown in FIGS. 20 and 21.

Furthermore, in the above first to third embodiments, the objective lens driving apparatus using the magnet magnetized in two, three or four polarities is explained, however, the present invention is not limited to this, a magnet magnetized in further multi-polarities may be applied to the objective lens driving apparatus.

As has been described heretofore, according to the first aspect of the invention, there is provided an objective lens drive apparatus in which a coil unit with a focus coil, a tracking coil and a tilt coil mounted thereon is disposed within the same magnetic gap of a magnetic circuit including at least one magnet magnetized in multi-polarities. In the present objective lens drive apparatus, the inclination of an objective lens can be adjusted using the magnet for focus and tracking driving, which eliminates the need for provision of a magnet which is exclusively used to adjust the inclination of the objective lens. Therefore, according to the first aspect of the invention, it is possible to prevent an increase in the cost as well as an increase in the size of the objective lens drive apparatus, which are otherwise caused by the adjustment of the inclination of the objective lens.

Also, according to the second aspect of the invention, there is provided an objective lens drive apparatus in which there are completed two magnetic circuits each including at least one magnet magnetized in multi-polarities and, within the magnetic gap of each of the two magnetic circuits, there is disposed a coil unit with a focus coil, a tracking coil and a tilt coil mounted thereon. In the present objective lens drive apparatus, the inclination of an objective lens can be adjusted using the magnets for focus and tracking driving, which eliminates the need for provision of a magnet which is exclusively used to adjust the inclination of the objective lens. Therefore, according to the second aspect of the invention, it is possible to prevent an increase in the cost of the objective lens drive apparatus as well as an increase in the size thereof, which are otherwise caused by the adjustment of the inclination of the objective lens.

Further, according to the third aspect of the invention, there is provided an objective lens drive apparatus in which a coil unit with a plurality of focus coils and a tracking coil mounted thereon is disposed within the same magnetic gap of a magnetic circuit including at least one magnet magnetized in multi-polarities, currents are supplied respectively to the plurality of focus coils included in the coil unit to thereby be able to execute focus servo due to the sum of drive forces generated in response to the supply of the currents, and moment is generated around the center of gravity of a movable part due to the difference between the drive forces to thereby be able to adjust the inclination of an objective lens simultaneously with the focus servo. In the present objective lens drive apparatus, using the right and left focus coils, not only the focus servo but also the adjustment of the inclination of the objective lens can be carried out, which eliminates the need for provision of a coil and a magnet which are exclusively used to adjust the inclination of the objective lens. Therefore, according to the third aspect of the invention, it is possible to prevent an increase in the cost of the objective lens drive apparatus as well as an increase in the size thereof, which are otherwise caused by the adjustment of the inclination of the objective lens.

What is claimed is:

1. An objective lens drive apparatus for use in an optical pickup, comprising:
a magnetic circuit including a magnet having at least three poles in a single side surface of the magnet; and
a coil unit including a focus coil, a tracking coil and a tilt coil,
wherein the focus coil, the tracking coil and the tilt coil are disposed within a magnetic gap of the magnetic circuit.

2. An objective lens drive apparatus according to claim 1, wherein the magnetic circuit includes a plurality of magnets, and the coil unit is disposed within the magnetic gap formed by the magnets.

3. An objective lens drive apparatus for use in an optical pickup, comprising:
two magnetic circuits each including a magnet having at least three poles in a single side surface of the magnet; and
a coil unit including a focus coil, a tracking coil and a tilt coil,
wherein the focus coil, the tracking coil and the tilt coil are disposed within a magnetic gap of one of the magnetic circuits.

4. An objective lens drive apparatus according to claim 3, wherein one of the magnetic circuits includes a plurality of magnets, and the coil unit is disposed within the magnetic gap.

5. An objective lens drive apparatus according to claim 3, wherein the coil unit includes a plurality of printed circuit boards, and the focus coil, the tracking coil and the tilt coil are separately mounted on the printed circuit boards.

6. An objective lens drive apparatus according to claim 3, wherein the coil unit includes a plurality of first printed circuit boards and second printed boards, and the focus coil and the tracking coil are mounted on the first printed circuit board and the tilt coil is mounted on the second printed board.

7. An objective lens drive apparatus according to claim 2, wherein the coil unit is fixed to the two side surfaces of a lens holder extending in parallel with a tracking direction.

8. An objective lens drive apparatus used in an optical pickup for detecting an inclination of an optical disk to adjust the inclination of an objective lens in accordance with an inclination signal of the optical disk, comprising:
a magnetic circuit including a magnet having at least three poles in a single side surface of the magnet; and
a coil unit including a focus coil, a tracking coil and a tilt coil,
wherein the focus coil, the tracking coil and the tilt coil are disposed within a magnetic gap of the magnetic circuit,
wherein a focus servo is executed by supplying currents respectively to a plurality of the focus coils due to a sum of drive forces generated in the plurality of focus coils, and
wherein the inclination adjustment of the objective lens is executed by generating moment around a center of gravity of a movable part due to a difference between the drive forces.

9. An objective lens drive apparatus according to claim 8, wherein the magnetic circuit includes a plurality of magnets, and the coil unit is disposed within the magnetic gap formed by the magnets.

10. An objective lens drive apparatus according to claim 8, wherein the coil unit includes a printed circuit board, and the focus coil and the tracking coil are mounted on the printed circuit board.

11. An objective lens drive apparatus used in an optical pickup for detecting an inclination of an optical disk to adjust the inclination of an objective lens in accordance with an inclination signal of the optical disk, comprising:
a magnetic circuit including a magnet having at least three poles in a single side surface of the magnet; and
a coil unit including a focus coil, a tracking coil and a tilt coil,
wherein the focus coil, the tracking coil and the tilt coil are disposed within a magnetic gap of the magnetic circuit,
wherein a tracking servo is executed by supplying currents respectively to a plurality of the tracking coils due to a sum of drive forces generated in the plurality of focus coils, and
wherein the inclination adjustment of the objective lens is executed by generating moment around a center of gravity of a movable part due to a difference between the drive forces.

12. An objective lens drive apparatus according to claim 11, wherein the magnetic circuit includes a plurality of magnets, and the coil unit is disposed within the magnetic gap formed by the magnet gaps.

13. An objective lens drive apparatus according to claim 11, wherein the coil unit includes a plurality of a printed circuit board, and the focus coil and the tracking coil are mounted on the printed circuit board.

14. An objective lens drive apparatus used in an optical pickup for detecting an inclination of an optical disk to adjust the inclination of an objective lens in accordance with an inclination signal of the optical disk, comprising:
two magnetic circuits respectively including a magnet having at least three poles in a single side surface of the magnet; and
a coil unit including a focus coil, a tracking coil and a tilt coil,
wherein the focus coil, the tracking coil and the tilt coil are disposed within a magnetic gap of the magnetic circuit,
wherein a focus servo is executed by supplying currents respectively to a plurality of the focus coils due to a sum of drive forces generated in the plurality of focus coils, and
wherein the inclination adjustment of the objective lens is executed by generating moment around a center of gravity of a movable part due to a difference between the drive forces.

15. An objective lens drive apparatus according to claim 14, wherein the magnetic circuit includes a plurality of magnets, and the coil unit is disposed within the magnetic gap formed by the magnets.

16. An objective lens drive apparatus according to claim 14, wherein the coil unit includes a printed circuit board, and the focus coil and the tracking coil are mounted on the printed circuit board.

17. An objective lens drive apparatus used in an optical pickup for detecting an inclination of an optical disk to adjust the inclination of an objective lens in accordance with an inclination signal of the optical disk, comprising:
two magnetic circuits respectively including a magnet having at least three poles in a single side surface of the magnet; and
a coil unit including a focus coil, a tracking coil and a tilt coil,
wherein the focus coil, the tracking coil and the tilt coil are disposed within a magnetic gap of the magnetic circuit,
wherein a tracking servo is executed by supplying currents respectively to a plurality of the tracking coils due to a sum of drive forces generated in the plurality of focus coils, and
wherein the inclination adjustment of the objective lens is executed by generating moment around a center of gravity of a movable part due to a difference between the drive forces.

18. An objective lens drive apparatus according to claim 17, wherein the magnetic circuit includes a plurality of magnets, and the coil unit is disposed within the magnetic gap formed by the magnet gaps.

19. An objective lens drive apparatus according to claim 17, wherein the coil unit includes a printed circuit board, and the focus coil and the tracking coil are mounted on the printed circuit board.
